(19) United States
(12) Patent Application Publication
(10) Pub. No.: US 2025/0346460 A1
(43) Pub. Date: Nov. 13, 2025

(54) A LIFTING YOKE FOR LIFTING A HEAVY ELEMENT

(71) Applicant: CRH CONCRETE A/S, Viby Sjælland (DK)

(72) Inventor: Esben NIELSEN, Aabenra (DK)

(21) Appl. No.: 18/868,453

(22) PCT Filed: Jun. 20, 2023
(86) PCT No.: PCT/DK2023/050155

§ 371 Date: Nov. 22, 2024

(30) Foreign Application Priority Data
Jun. 28, 2022 (DK) PA 2022 00622

(51) Int. Cl. B66C 1/66; B66C 13/40; E04G 21/14; E04G 21/16

(52) U.S. Cl. CPC B66C 1/666; B66C 13/40; E04G 21/147; E04G 21/167

(57) ABSTRACT

A lifting yoke 200 for lifting a heavy element 300 is disclosed, wherein the heavy element being of the type comprising a body having two or more lifting anchors 302 exposed at an edge 304 thereof. The lifting yoke 200, in the orientation intended during lifting, comprises: a horizontally arranged beam 2 having an extension in a longitudinal direction X between a first extreme end 4 and a second extreme end 6, a first grabbing mechanism 8, a second grabbing mechanism 10. The first grabbing mechanism 8 is being connected to said horizontally arranged beam 2 and is comprising a first clutch 12 which is being configured to be able to shift between an engaged configuration for engagement with a lifting anchor 302 of a heavy element 300, and a disengaged configuration for disengaging with said lifting anchor 302, and vice versa, wherein said first clutch 12 comprises a first clutch actuator 14, which is being configured for enabling remote controlling of the configuration of said first clutch 12; wherein said second grabbing mechanism 10 is being connected to said horizontally arranged beam 2 and is comprising a second clutch 16 which is being configured to be able to shift between an engaged configuration for engagement with a lifting anchor 302 of a heavy element 300 and a disengaged configuration for disengaging with said lifting anchor 302, and vice versa, wherein said second clutch 16 comprises a second clutch actuator 18 which is being configured for enabling remote controlling of the configuration of said second clutch 16; wherein said first clutch 12 and said second clutch 16 are being arranged at mutual distance D; wherein said lifting yoke 200 comprises one or more attachment means 20 for attachment of a lifting chain/wire 22 to be connected to a lifting boom of a crane.

### FIELD OF THE INVENTION

The present invention relates in general to the field of lift and moving heavy elements used in construction work.

More specifically, the present invention relates in a first aspect to a lifting yoke for lifting and moving heavy elements, such as concrete wall elements, for use in construction work.

In a second aspect the present invention relates a use of a lifting yoke according to the first aspect for lifting a heavy element.

In a third aspect the present invention relates to a method for lifting a heavy element.

In a fourth aspect the present invention relates to a method for moving a heavy element from one location to another location.

### BACKGROUND OF THE INVENTION

Within the construction industry it has been customary for decades, when building relatively large buildings, such as multi floor office buildings or multi floor residential buildings, to use prefabricated concrete elements as building blocks forming a skeleton of the building. One type of such prefabricated concrete elements is wall elements which are intended to act as outer walls and/or partition walls within the interior of the structure.

Such prefabricated wall elements are typically made by starting binding together a reinforcing steel frame in a pouring form having the desired geometrical dimensions and shape. Once the reinforcing frame has been completed, concrete in a flowable state is added to the pouring form and the concrete is allowed to cure.

The pouring form is typically arranged in a lying down position.

The reinforcing frame is designed in such a way that upon curing two or more lifting anchors will be exposed at and extend from a surface at an edge or rim of the cured wall element.

Once cured, a crane will lift the concrete wall element out of its pouring form and transport it to a storing site, before it is going to be shipped to its final destination at a construction site.

The wall element is lifted by the crane by manually attaching lifting hooks of lifting straps to the lifting anchors which are being present at an edge or at a rim of the wall element.

At its storing site the wall element is arranged on the ground with its lifting anchor at the upper edge or rim.

As wall elements for use in construction work in building structures, such as buildings, notoriously are having a height of around three meters or more it will be necessary for the individual who is responsible for the manually attachment and detachment the lifting hooks to use a ladder or the like in order to reach the lifting anchors at the upper edge or rim of the wall element.

Moreover, as each wall element is lifted by two straps having a relatively large mutual distance it will also be necessary for the individual who is responsible for the manually attachment and detachment the lifting hooks to climb the ladder twice with intermittent movement of the ladder each time the lifting straps are to be attached to the wall element and each time the lifting straps are to be detached form the wall element.

In a typically manufacturing and delivery process the concrete wall element has to be lifted from the pouring form and transported to a storage site at the manufacturing premise.

Subsequently, upon delivery of the wall element, the wall element will have to be loaded on a truck or lorry and transported to a construction site where it may be placed in the structure being build right away. Alternatively, at the construction site, the wall element may be stored at a preliminary storage site before the structure being built is ready for having that exact building element mounted in the structure.

Except for lifting the wall element out of its pouring form, any of the above listed operational lifting steps involves the necessity of a worker to i) arrange a ladder at a position of a first lifting anchor of the wall element, ii) to climb the ladder and attach or detach a lifting strap to the first lifting anchor, iii) to return to the support surface of the ladder and move the ladder to a position corresponding to the second lifting anchor of the wall element, iv) to climb the ladder once more and attach or detach another lifting strap to the second lifting anchor; v) to return to the support surface of the ladder once more and remove the ladder.

Accordingly, very many manual operational steps are involved in order to move a concrete wall element form one location to another. All these operational steps take up a not insignificant amount of time and moreover involves a worker in addition to the worker who operates the crane used for lifting the wall element.

Additionally, climbing ladders is considered to be ergonomically unhealthy and also involves the risk of fall accidents.

Moreover, having workers placed in close vicinity to a heavy wall element is hazardous because of the potential risk that the wall element will tilt or fall over, or because of the potential risk that an operator of the crane is having trouble controlling the lifting operation properly and in the intended safe way.

Accordingly, a need persists for improved technology which eliminated the above-described disadvantages.

It is the objective of the present invention to provide such technology.

Although the invention has been conceived and put into practice with the view to be used for lifting building elements having two or more lifting anchors exposed at a surface thereof, it is clear that the invention in its various aspects and embodiment thereof may be used for lifting other types of heavy elements having lifting anchors exposed at a surface thereof. In the present description and in the appended claims the invention is accordingly described and claimed with reference to lifting of a heavy element.

In the present description and in the appended claims a heavy element shall be construed to mean an element having a weight of 100 kg or more.

### BRIEF DESCRIPTION OF THE INVENTION

These objectives are fulfilled according to the first, the second, the third and the fourth aspect of the present invention.

Accordingly, the first aspect of the present invention relates to a lifting yoke for lifting a heavy element; said heavy element being of the type comprising a body having two or more lifting anchors exposed at an edge thereof;
wherein said lifting yoke, in the orientation intended during lifting, comprises:
   a horizontally arranged beam having an extension in a longitudinal direction between a first extreme end and a second extreme end;
   a first grabbing mechanism;
   a second grabbing mechanism;
wherein said first grabbing mechanism is being connected to said horizontally arranged beam and is comprising a first clutch which is being configured to be able to shift between an engaged configuration for engagement with a lifting anchor of a heavy element, and a disengaged configuration for disengaging with said lifting anchor, and vice versa, wherein said first clutch comprises a first clutch actuator, which is being configured for enabling remote controlling of the configuration of said first clutch;
wherein said second grabbing mechanism is being connected to said horizontally arranged beam and is comprising a second clutch which is being configured to be able to shift between an engaged configuration for engagement with a lifting anchor of a heavy element and a disengaged configuration for disengaging with said lifting anchor, and vice versa, wherein said second clutch comprises a second clutch actuator which is being configured for enabling remote controlling of the configuration of said second clutch;
wherein said first clutch and said second clutch are being arranged at mutual distance D;
wherein said lifting yoke comprises one or more attachment means for attachment of a lifting chain/wire to be connected to a lifting boom of a crane.

In a second aspect the present invention relates to a use of a lifting yoke according to the first aspect for lifting a heavy element.

In a third aspect the present invention relates to a method for lifting a heavy element of the type having two or more lifting anchors exposed at an edge thereof; said method comprises the following step;
i) providing a lifting yoke according to the first aspect of the invention;
ii) providing said heavy element to be lifted in an orientation in which said lifting anchors are positioned at an upper edge thereof;
iii) arranging said lifting yoke above said heavy element in an orientation essentially corresponding to a plane defined by said heavy element;
iv) approaching said lifting yoke to said heavy element;
v) remotely enabling said first clutch of said first grabbing mechanism to engage with a first lifting anchor of said heavy element, and remotely enabling said second clutch of said second grabbing mechanism to engage with a second lifting anchor of said heavy element;
vi) lifting said lifting yoke, such as by a lifting boom of a crane, and thereby also lifting said heavy element.

In a fourth aspect the present invention relates to a method for moving a heavy element of the type having two or more lifting anchors exposed at an edge thereof from one location to another location, said method comprises the steps of:
a) performing steps i) to vi) of the method according to the third aspect of the present invention;
b) once lifted; moving the location of said heavy element, such as by moving the crane or the lifting boom thereof, to a new location;
c) lowering the lifting yoke, and thereby also lowering said heavy element, thereby making said heavy element rest on a support at said new location;
d) remotely enabling said first clutch of said first grabbing mechanism to disengage with said first lifting anchor of said heavy element, and remotely enabling said second clutch of said second grabbing mechanism to disengage with said second lifting anchor of said heavy element;
e) moving said lifting yoke from said new location.

The present invention in its various aspects provides for more time efficient and more safe working operations in relation to lifting and/or moving heavy elements, such as in the form of concrete wall elements.

### BRIEF DESCRIPTION OF THE FIGURES

FIG. 1 is a perspective view illustrating a heavy element in the form of a concrete wall element to be lifted.

FIG. 2 is a photograph showing a perspective view of a typical type of a lifting anchor which is being used for embedding into a body of a concrete wall element.

FIGS. 3a-3c are plane views illustrating the working principle of a lifting yoke according to the first aspect of the present invention.

FIG. 4 is a drawing illustrating in a perspective view a lifting yoke according to the present invention and corresponding to a variation of the principle illustrated in FIG. 3c.

FIG. 5a is a close-up perspective drawing illustrating details of the support arrangement of the lifting yoke according to the first aspect of the present invention.

FIG. 5b is a close-up drawing illustrating in a perspective view a support leg suspension for suspending a support leg to the horizontally arranged beam of the lifting yoke of the first aspect of the invention.

FIG. 6 is a close-up drawing showing in a perspective view details relating to the position of the first grabbing mechanism of a lifting yoke according to the first aspect of the present invention.

FIG. 7 is close-up drawing showing in a perspective view, details of the first clutch of a lifting yoke according to the first aspect of the present invention.

FIG. 8 is a drawing showing in a perspective view an embodiment of an actuator for engaging and disengaging the clutch of the first grabbing mechanism and the second mechanism.

FIG. 9 is a plane view illustrating a locking element of an alternative embodiment of a clutch of a grabbing mechanism of the lifting yoke.

FIG. 10 is a photograph illustrating an alternative type of lifting anchor of a heavy element.

FIG. 11 is a plan view illustrating an alternative embodiment of the clutch of a grabbing mechanism of the lifting yoke.

FIG. 12 is a photograph illustrating yet an alternative type of a lifting anchor of a heavy element which comprises an expose female thread.

FIG. 13 is a partly cross-sectional view illustrating yet an alternative embodiment of the clutch of a grabbing mechanism of the lifting yoke.

FIG. 14 is a photograph illustrating an alternative type of a lifting anchor of a heavy element which comprises an expose male thread.

FIG. 15 is a schematic diagram illustrating the working mode of the control system for controlling the lifting yoke of the present invention.

### DETAILED DESCRIPTION OF THE INVENTION

### The First Aspect of the Present Invention

The present invention relates in a first aspect to a lifting yoke 200 for lifting a heavy element 300; said heavy element being of the type comprising a body having two or more lifting anchors 302 exposed at an edge 304 thereof;
wherein said lifting yoke 200, in the orientation intended during lifting, comprises:
   a horizontally arranged beam 2 having an extension in a longitudinal direction X between a first extreme end 4 and a second extreme end 6;
   a first grabbing mechanism 8;
   a second grabbing mechanism 10,
wherein said first grabbing mechanism 8 is being connected to said horizontally arranged beam 2 and is comprising a first clutch 12 which is being configured to be able to shift between an engaged configuration for engagement with a lifting anchor 302 of a heavy element 300, and a disengaged configuration for disengaging with said lifting anchor 302, and vice versa, wherein said first clutch 12 comprises a first clutch actuator 14, which is being configured for enabling remote controlling of the configuration of said first clutch 12;
wherein said second grabbing mechanism 10 is being connected to said horizontally arranged beam 2 and is comprising a second clutch 16 which is being configured to be able to shift between an engaged configuration for engagement with a lifting anchor 302 of a heavy element 300 and a disengaged configuration for disengaging with said lifting anchor 302, and vice versa, wherein said second clutch 16 comprises a second clutch actuator 18 which is being configured for enabling remote controlling of the configuration of said second clutch 16;
wherein said first clutch 12 and said second clutch 16 are being arranged at mutual distance D;
wherein said lifting yoke 200 comprises one or more attachment means 20 for attachment of a lifting chain/wire 22 to be connected to a lifting boom of a crane.

Accordingly, the lifting yoke of the first aspect of the invention allows for lifting heavy elements, such as building elements in the form of wall elements in a way where manually attaching lifting hooks or the like to the lifting anchors of the heavy elements by having a worker climb a ladder in order to attach and detach the lifting hooks to the heavy element can be avoided. This is attained by having comprised in the lifting yoke of the first aspect of the present invention of remotely controlled clutches that are configured to engage with and disengage from the lifting anchors of heavy elements by remote controlling thereof.

In one embodiment of the lifting yoke of the first aspect of the present invention, said horizontally arranged beam comprises:
a main beam 24 having a first end 26 and a second end 28; and
a first auxiliary beam 30 having a first end 32 and a second end 34;
wherein said first auxiliary beam 30 is being attached to said main beam 24 at said first end 26 thereof in such a way that said first auxiliary beam 30 is being displaceable, in said longitudinal direction (X), relative to said main beam 24;
wherein said first grabbing mechanism 8 is being connected to said main beam 24; and
wherein said second grabbing mechanism 10 is being connected to said first auxiliary beam 30.

Providing a displaceable first auxiliary beam 30, relative to said main beam 24 allows for altering the mutual distance of the first clutch 12 and the second clutch 16, thereby enabling fitting the lifting yoke to different designs and sizes of heavy elements to be lifted.

In one embodiment of this embodiment, the main beam 24, at least at a first end 26 thereof is being hollow, said first auxiliary beam 30 is being arranged in the interior of said hollow first end 26 of said main beam 24.

Having the first auxiliary beam 30 arranged in the interior of the hollow first end 26 of the main beam 24 provides strength to the yoke, yet allowing adjusting the mutual distance between of the first clutch 12 and the second clutch 16.

In one embodiment of this embodiment, the lifting yoke comprises a first beam actuator 36; wherein said first beam actuator is being configured for adjusting the position of displacement, in said longitudinal direction X, of said first auxiliary beam 30, relative to said main beam 24.

Providing the lifting beam with such an actuator allows for remote adjustment of the mutual distance D between of the first clutch 12 and the second clutch 16.

In one embodiment of the lifting yoke of the first aspect of the present invention, the horizontally arranged beam comprises:
a main beam 24 having a first end 26 and a second end 28; and
a first auxiliary beam 30 having a first end 32 and a second end 34;
a second auxiliary beam 38 having a first end 40 and a second end 42;
wherein said first auxiliary beam 30 is being attached to said main beam 24 at said first end 26 thereof in such a way that said first auxiliary beam 30 is being displaceable, in said longitudinal direction (X), relative to said main beam 24;
wherein said second auxiliary beam 38 is being attached to said main beam 24 at said second end 28 thereof in such a way that said second auxiliary beam 38 is being displaceable, in said longitudinal direction (X), relative to said main beam 24;
wherein said first grabbing mechanism 8 is being connected to said first auxiliary beam 30; and
wherein said second grabbing mechanism 10 is being connected to said second auxiliary beam 38.

Providing the lifting yoke with a main beam 24 and two auxiliary beams 30,38 allows lifting the lifting yoke by a crane or the like in the main beam itself, and allows for adjusting the displacement of each of the auxiliary beams, relative to the main beam. Hereby it is easy to balance the lifting yoke, irrespective of the weight of the heavy element being lifted and irrespective of the locations of the positions of the lifting means of the horizontally arranged beam 2.

In one embodiment of this embodiment, the main beam 24, at least at a first end 26 thereof is being hollow, and wherein said first auxiliary beam 30 is being arranged in the interior of said hollow first end 26 of said main beam 24; and
wherein said main beam 24, at least at a second end 28 thereof is being hollow, and wherein said second auxiliary beam 38 is being arranged in the interior of said hollow second end 28 of said main beam 24.

Having the first auxiliary beam 30 and the second auxiliary beam 38 arranged in the interior of a hollow end of the main beam 24 provides strength to the yoke, yet allowing adjusting the mutual distance between of the first clutch 12 and the second clutch 16, while still balancing the weight being lifted.

In one embodiment of this embodiment the lifting yoke comprises a first beam actuator 36; wherein said first beam actuator 36 is being configured for adjusting the position of displacement, in said longitudinal direction X, of said first auxiliary beam 30, relative to said main beam 24; and
wherein said lifting yoke comprises a second beam actuator 44; wherein said second beam actuator is being configured for adjusting the position of displacement, in said longitudinal direction X, of said second auxiliary beam 38, relative to said main beam 24.

In one embodiment of the lifting yoke of the first aspect of the present invention, the first grabbing mechanism 8 is being connected to said horizontally arranged beam 2 in such a way that said that said first grabbing mechanism 8 is being displaceable, in said longitudinal direction X, relative to said horizontally arranged beam 2; and/or wherein said second grabbing mechanism 10 is being connected to said horizontally arranged beam 2 in such a way that said that said second grabbing mechanism 10 is being displaceable, in said longitudinal direction X, relative to said horizontally arranged beam 2.

Accordingly, in this embodiment, the grabbing mechanism(s) itself/themselves, rather than an auxiliary beam(s) is/are being configured to be displaceable along the direction X of the horizontally arranged beam 2.

This may provide a simpler, less heavy design of the lifting yoke.

In one embodiment of this embodiment the horizontally arranged beam 2 comprises:
a main beam 24 having a first end 26 and a second end 28; and
a first auxiliary beam 30 having a first end 32 and a second end 34;
a second auxiliary beam 38 having a first end 40 and a second end 42;
wherein said first auxiliary beam 30 is being fixed to said main beam 24 at said first end (26) thereof;
wherein said second auxiliary beam 38 is being fixed to said main beam 24 at said second end 28 thereof;
wherein said first grabbing mechanism 8 is being connected to said first auxiliary beam 30; and
wherein said second grabbing mechanism (10) is being connected to said second auxiliary beam (38).

In one embodiment of the above two embodiment the lifting yoke comprises a first beam actuator 36; wherein said first beam actuator 36 is being configured for adjusting the position of displacement, in said longitudinal direction X, of said first grabbing mechanism 8, relative to said horizontally arranged beam 2; and/or
the lifting yoke comprises a second beam actuator 44; wherein said second beam actuator is being configured for adjusting the position of displacement, in said longitudinal direction X, of said second grabbing mechanism, relative to said horizontally arranged beam 2.

In one embodiment of the lifting yoke of the first aspect of the present invention the first beam actuator 36 and optionally also said second beam actuator 44 is/are being configured for remote controlling thereof.

In one embodiment of the lifting yoke of the first aspect of the present invention the first grabbing mechanism 8 and the second grabbing mechanism 10 each comprises a fastening element 46, such as a throughgoing hole for fastening a shackle 48 or the like thereto.

The fastening element 46 may be a throughgoing hole in the body or other part of the grabbing mechanisms 8,10. Alternatively, it may be an eye bolt or the like thereof.

In one embodiment of the lifting yoke of the first aspect of the present invention the lifting yoke furthermore comprising a stress reducing chain/wire 50 having in each of its ends a shackle 48 or the like to be mounted to said fastening element 46 of said first grabbing mechanism 8 and to said second grabbing mechanism 10, respectively, wherein said stress reducing chain/wire 50 is being configured to be connected to the lifting chain/wire which, by means of a lifting boom of a crane, is configured for lifting said lifting yoke 200, thereby reducing the stress encountered by said first grabbing mechanism 8 and said second grabbing mechanism 10 due to the weight being lifted.

Hereby stresses one the grabbing mechanisms 8,10 due to the weight of the heavy element being lifted may be eased.

In some embodiments of the lifting yoke of the first aspect of the invention, the stress reducing chain/wire 50 is mounted to said fastening element 46 of the first grabbing mechanism 8 and the second grabbing mechanism 10.

The stress reducing chain/wire 50 may comprises, in its opposite ends, a shackle or carbineer hook or other kind of releasable fastening means. Alternatively, the stress reducing chain/wire 50 may, in its two ends, fixedly form a loop, such as by means of a talurite clamp in such a way that each loop of the stress reducing chain/wire 50 is being fixed to the first grabbing mechanism 8 and the second grabbing mechanism 10, respectively, such as to the fastening element 46 thereof.

In one embodiment of the lifting yoke of the first aspect of the present invention the lifting yoke furthermore comprising a “zero gravity” balancing device 52, such as a spring-loaded balancing device, having an upper attachment point 54 for an upper hoist and a lower attachment point 56 for a lower hoist, wherein said upper attachment point 54 is being configured to be connected to a lifting chain/wire for lifting by a lifting boom of a crane, and wherein said lower attachment point 56 is being configured for being attached to one or more attachment means 20 of said lifting yoke 200; and wherein said stress reducing chain/wire 50 is being connected to said lifting chain/wire to be lifted by a lifting boom of a crane.

A “zero gravity” balancing device comprises a housing having arranged therein a spring-loaded roller comprising a cable which is being winded around the roller. The housing comprises a fastening means, such as a hook, arranged at a top portion thereof. One end of the cable of the balancing device exits the housing of the balancing device at a lower part thereof and the opposite end of the cable of the balancing device may be fastened to the roller. Because the roller is being spring-loaded, the position of the load of the “zero gravity” balancing device can be moved upward and downward by exerting a force thereto. The load fastened to a “zero gravity” balancing device will attain a vertical position as determined by the weight of the load and by the spring constant of the device. As the load carried by such a “zero gravity” balancing device is counteracted by the spring thereof, a vertical movement of the load being hold by the “zero gravity” balancing device can be performed by exerting only minor vertical force thereto.

In one embodiment of the lifting yoke of the first aspect of the present invention the lifting yoke, the horizontal position of the first grabbing mechanism 8 essentially corresponds to said first extreme end 4 of said horizontally arranged beam 2; and the horizontal position of said second grabbing mechanism 10 essentially corresponds to said second extreme end 6 of said horizontally arranged beam 2.

Hereby a maximum capacity, in terms of large mutual distance between the two clutches 12,16 can be attained.

In one embodiment of the lifting yoke of the first aspect of the present invention the horizontally arranged beam 2 comprises a number N of attachment means 20 for attachment, at different points, of a lifting chain/wire to be connected to a lifting boom of a crane, wherein said number N of attachment means 20 are being arranged along the longitudinal extension of said horizontally arranged beam 2, wherein N is an integer selected from the ranges of 2-55, such as 3-50, for example 4-45, such as 6-40, for example 10-35, e.g. 15-30, such as 20-25.

Having a plurality of such attachment means enables easy balancing of the heavy element to be lifted.

In one embodiment of the lifting yoke of the first aspect of the present invention one or more of the attachment means 20 for attachment of a lifting chain/wire independently is being in the form of a threaded hole in said horizontally arranged beam 2 or eye bolts arranged at said horizontally arranged beam 2.

These types of attachment means have proven beneficial.

In one embodiment of the lifting yoke of the first aspect of the present invention the mutual distance D, in a horizontally direction X, between said first clutch 12 and said second clutch 16 is being fixed at a distance, or is being configured to be variable at a distance; said distance falling within the ranges of 0.5 m-25 m, such as 1-24 m, for example 2-23 m, e.g. 3-22 m, such as 4-21 m, such as 5-20 m, for example 6-19 m, such as 7-18 m, for example 8-17 m, such as 9-16 m, e.g. 10-15 m, such as 11-14 m or 12-13 m.

Hereby lifting of heavy elements having a relatively large dimensions is possible.

In one embodiment of the lifting yoke of the first aspect of the present invention the lifting yoke comprises a first distance element 58, wherein said first distance element is being connected to a first position at said horizontally arranged beam 2 in a downward pointing direction (Y); and wherein said first grabbing mechanism 8 is being connected to said first distance element 58 at a lower portion 60 thereof; and wherein said lifting yoke comprises a second distance element 62, wherein said second distance element is being connected to a second position at said horizontally arranged beam 2 in a downward pointing direction (Y); and wherein said second grabbing mechanism 10 is being connected to said second distance element 62 at a lower portion 64 thereof.

Providing the grabbing mechanisms 8,10 at a lower portion of the distance elements implies crating a distance between the clutches 12,16 and the rest of the mechanisms of the lifting yoke, whereby minimizing the risk of collision between delicate mechanical parts of the lifting yoke with the heavy element to be lifted in a lifting operation.

In one embodiment of the lifting yoke of the first aspect of the present invention the lifting yoke comprises a support arrangement 66 for aiding in aligning said lifting yoke 200, relative to a heavy element 300, prior to a lifting operation, wherein said support arrangement 66 comprises one or more support legs 68a,68b each having a first end 70 and opposite second end 72, wherein in respect of one or more of said one or more support legs 68a,68b, said support leg at its first end 70 is/are being connected to said horizontally arranged beam 2 in such a way that said support leg 68a,68b extends in a downward direction Y; and wherein, in respect of one or more of said one or more support legs 68a,68b, said support leg at its second end 72 comprises a support element 74 comprising a support surface 76 for abutting a heavy element 300 prior to lifting thereof.

Such a support arrangement allows aligning the orientation of the lifting yoke with the heavy element to be lifted prior to engaging the clutches 12,16 with the lifting anchors 302 of the heavy element. Hereby the operation of engaging the clutches 12,16 to the lifting anchor 302 will be easier.

In one embodiment of this embodiment and in respect of one or more of said one or more support legs 68a,68b, said support leg comprises an upper leg part 78 and a lower leg part 80; wherein said upper leg part 78 is being connected to said horizontally arranged beam 2 and wherein said lower leg part 80 is configured to be displaceable, in a longitudinal direction Y thereof, in relation to said upper leg part 78, between an upper extreme position and a lower extreme position; and wherein said lower leg part 80, at a lower portion thereof comprises said support element 74 comprising said support surface 76.

Hereby the support surface 76 can be abutted to the surface or edge of the heavy element 302, irrespective of the geometry of the heavy element.

In one embodiment of this embodiment and in respect of one or more of said one or more support legs 68a,68b, said upper leg part 78 comprises hollow tube and wherein said lower leg part 80 is being loosely arranged in the interior of said hollow tube, thereby allowing said lower leg part 80 to be displaceable within the interior of said upper leg part 78; or wherein said lower leg part 80 comprises hollow tube and wherein said upper leg part 78 is being loosely arranged in the interior of said hollow tube, thereby allowing said lower leg part 80 to be displaceable outside said upper leg part 78.

Having one leg part arranged in the interior of the upper leg part is an easy and efficient way of making the two leg pars displaceable in relation to each other.

In one embodiment of this embodiment and in respect of one or more of said one or more support legs 68a,68b, said support surface 76 comprises two mutually perpendicular partial surfaces 76a,76b configured to abut an edge 304 of the heavy element 300 upon alignment of the lifting yoke 200 relative to said heavy element 300 and prior to lifting thereof.

Hereby the surfaces 76a, 76b can be abutted to an edge or a corner of the heavy element 300 to be lifted.

In one embodiment of this embodiment and in respect of one or more of said one or more support legs 68a,68b, said lifting yoke comprises a support leg suspension 82, wherein said support leg suspension comprises a support leg rail 84 having an extension in a direction (Z) which is essentially perpendicular to said horizontal direction (X) and to said vertical direction (Y), wherein said support leg rail 84 is being connected to said horizontally arranged beam 2; wherein said support leg suspension 82 comprises a displacement element 86 which is being coupled to said support leg rail 84, wherein said displacement element 86 is being configured to be able to be displaced along the extension of said support leg rail 84 and along the direction (Z) thereof, and wherein said support leg 68a,68b is being connected to said displacement element 86.

Hereby the position, in the Z direction of the support leg 68a,68b in relation to the horizontally arranged beam 2 of the lifting yoke can be adjusted.

In one embodiment of this embodiment and in respect of one or more of said one or more support legs 68a,68b, said support leg suspension 82 comprises a support leg actuator 88; wherein said support leg actuator 88 is being configured for adjusting the position of said displacement element 86, relative to said support leg rail 84 and along said direction (Z).

In one embodiment of this embodiment and in respect of one or more of said one or more support legs 68a,68b, said support leg actuator 88 is being configured to be remotely controlled.

In one embodiment of this embodiment the number of support legs 68a,68b is two and these two support legs 68a,68b are being connected to said horizontally beam 2 at predetermined positions thereof.

In one embodiment of the lifting yoke of the first aspect of the present invention and in respect of said first grabbing mechanism 8 and said second grabbing mechanism 10, respectively, said clutch 12,16 comprises:
a body 90, and
a locking element 92;
wherein said body 90 comprises an oblong recess 94 defining an inner wall 96; and wherein said body furthermore comprises a locking element channel 98 which extend from opposite sides 100a, 100b of said inner wall 96 of said oblong recess 94 and into said body 90;
wherein said locking element 92 is being accommodated in said locking element channel 98;
wherein said locking element 92 is being configured, upon actuation thereof, to be slit in said locking element channel 98 between a retracted position and an expanded position, and vice versa;
wherein, when said locking element 92 is in its retracted position, access is provided from the outside into said oblong recess 94 of said body 90; and wherein, when said locking element is in its expanded position, access into said oblong recess 94 of said body 90 is being blocked by said locking element 92.

This embodiment enables the clutch 12,16, to engage with and to disengage from a lifting anchor 302 of a heavy element 300, wherein said lifting anchor 302 is of the type comprising an exposed stem 306 having a throughgoing opening 308 in it.

In one embodiment of the lifting yoke of the first aspect of the present invention and in respect of said first clutch 12 and/or said second clutch 16, said locking element channel 98 is having a circular extension, and wherein said locking element 92 is having a circular extension, thereby making said locking element 92 perform an essential rotational movement upon being slit in said locking element channel 98 between said retracted position and said expanded position, or vice versa.

In one embodiment of this embodiment and in respect of said first clutch 12 and/or said second clutch 16, said locking element channel 98 is having a linear extension, and wherein said locking element 92 is having a linear extension, thereby making said locking element 92 perform an essential linear movement upon being slit in said locking element channel 98 between said retracted position and said expanded position, or vice versa.

These two embodiments provide in an easy and efficient way the engagement and disengagement of the clutches 12,16.

In an alternative embodiment and in respect of said first clutch 12 and/or said second clutch 16, said locking element 92 comprises an elongate member 106 comprising in its one end a first prong 108a and a second prong 108b with an open space 109 therebetween, wherein said open space 109 is being configured for accommodating a stem 306 of a lifting anchor 302 of a heavy element to be lifted.

This embodiment allows engagement with a lifting anchor 302 of the type comprising a stem 306 with a head 310 in its one end, wherein said head 310 is having an extension in a direction perpendicular to a longitudinal extension of said stem 306, which is larger than the extension of said stem 306 in that direction.

In an alternative embodiment of the above embodiment the locking element channel 98 of said body 90 comprises a common cavity for accommodating both of the two prongs 108a, 108b of said locking element 92, or wherein said locking element channel 98 of said body 90 comprises two separate cavities, wherein each of these two cavities are configured for accommodating its own individual prong of the two prongs 108a, 108b.

In one embodiment of the lifting yoke of the first aspect of the present invention and in respect of said first grabbing mechanism 8 and said second grabbing mechanism 10, respectively, said clutch 12,16 comprises:
a body 90, and
a locking element 92;
wherein said body comprises an electric motor 120 having an axle 110 and wherein said locking element 92 comprises a male thread 112 connected to said axle 110, whereby said electric motor 120 is being configured to rotate said axle 110 thereof in one or and in another rotational direction upon remote controlling thereof, thereby enabling engagement of said clutch 12,16 with a lifting anchor 302 of a heavy element, in a situation wherein said lifting anchor 302 comprises an exposed female thread 312.

In an embodiment of this embodiment, the male thread 112 at its end comprises a tapered portion 114 for aiding in guiding said male thread 112 into a corresponding exposed female thread 312 of a lifting anchor 302 of a heavy element 300.

In one embodiment of the lifting yoke of the first aspect of the present invention and in respect of said first grabbing mechanism 8 and said second grabbing mechanism 10, respectively, said clutch 12,16 comprises:
a body 90, and
a locking element 92;
wherein said body comprises an electric motor 120 having an axle 110 and wherein said locking element 92 comprises a female thread 116 connected to said axle 110, whereby said electric motor 120 is being configured to rotate said axle 110 thereof in one or and in another rotational direction upon remote controlling thereof, thereby enabling engagement of said clutch 12,16 with a lifting anchor 302 of a heavy element, in a situation wherein said lifting anchor 302 comprises an exposed male thread 314.

In one embodiment of this embodiment, the locking element at an end portion of said female thread 116 comprises a chute portion 118 for aiding in guiding said exposed male thread 314 of a lifting anchor 302 of a heavy element 300 into said female thread 116 of said clutch.

In one embodiment of the lifting yoke of the first aspect of the present invention and in respect of said first grabbing mechanism 8 and said second grabbing mechanism 10, respectively, said clutch 12,16 comprising a locking mechanism comprising of the type used for lifting a standard freight container; thereby enabling engagement of said clutch 12,16 with a lifting anchor 302 of a heavy element, in a situation wherein said lifting anchor 302 comprises one or more locking holes used in a standard freight container.

In one embodiment of the lifting yoke of the first aspect of the present invention the lifting yoke comprises one or more, such as two image capturing devices 102a,102b for capturing images of an area in vicinity of the first grabbing mechanism 8 and the second grabbing mechanism 10, respectively; or preferably of an area in vicinity of the first clutch 12 and the second clutch 16, respectively.

Hereby an operator of the lifting yoke can be provided with visual information relating to the orientation of each of the grabbing mechanisms 8,12 and/or each of the clutches 12,16, relative to the heavy element to be lifted.

In one embodiment of the lifting yoke of the first aspect of the present invention the horizontally arranged beam 2 comprises a balancing ballast 104, such as a ballast made of concrete, for counteracting any tilting of the lifting yoke out of the XY-plane.

In one embodiment of this embodiment the heavy element 300 is being a concrete element, such as a concrete wall element, or wherein said heavy element 300 is being an element for a wind turbine, such as a wind turbine blade or a tower section of a wind turbine, a silo or a section of a silo; or a freight container.

In one embodiment of the lifting yoke of the first aspect of the present invention the lifting yoke 200 comprises a battery 150 for providing power to one or more of said first clutch actuator 14,120; said second clutch actuator 18,120; said support leg actuator(s) 88; said first beam actuator 36; said second beam actuator 44, and to a control interphase 404.

In one embodiment of the lifting yoke of the first aspect of the present invention the lifting yoke furthermore comprising a control system 400 for controlling the operation thereof, wherein said control system 400 comprising:
a control panel 402 for enabling an operator to provide input instructions for controlling the operation of said lifting yoke; and
a control interphase 404;
wherein said control panel 402 is being connected to said control interphase 404, thereby enabling conveying of operational instructions from said control panel (402) to said control interphase 404;
wherein said control interphase 404 is being coupled to one or more of the following elements of the lifting yoke 200: said first clutch actuator 14,120; said second clutch actuator 18,120; said support leg actuator(s) 88; said first beam actuator 36; said second beam actuator 44 for enabling remote controlling thereof.

Such a control system enables remote control of the various actuators and motors of the lifting yoke.

In one embodiment of the lifting yoke of the first aspect of the present invention the control panel 402 comprising input means 406, such as one or more knobs, joysticks, or the like for providing instructions by an operator.

In one embodiment of the lifting yoke of the first aspect of the present invention the control panel 402 comprises a display 408 for displaying details relating to the operational status of said lifting yoke 200.

In one embodiment of the lifting yoke of the first aspect of the present invention the control panel 402 comprises a monitor 410 for displaying images captured by said image capturing devices 102a,102b; wherein said control interphase 404 optionally comprising an image processing device 418 for processing images captured by said image capturing devices 102a, 102b.

In one embodiment of the lifting yoke of the first aspect of the present invention control panel 402 and said control interphase 404 are being connected by a cable 416, thereby enabling wired controlling said lifting yoke 200 from said control panel 402.

In one embodiment of the lifting yoke of the first aspect of the present invention control panel 402 comprises a first wireless communication unit 412 operating via electromagnetic radiation, and wherein said control interphase comprises a second wireless communication unit 414 operating via electromagnetic radiation; wherein said first wireless communication unit 412 and said second wireless communication unit 414 are configured to communicate with each other, thereby enabling wireless controlling said lifting yoke 200 from said control panel 402.

A wireless operation of the lifting yoke provides easier operation of the lifting yoke.

In one embodiment of the lifting yoke of the first aspect of the present invention said control interphase 404 is being arranged at or near said horizontally arranged beam 2 of said lifting yoke 200. Hereby short distance to the various actuators and motors is ensured.

In one embodiment of the lifting yoke of the first aspect of the present invention the image processing device 416 of said control interphase 404 is being coupled to a central processing unit (CPU) 422 and a data storage 424, wherein said image processing device 418 is being configured, based on images received by said image capturing devices 102a,102b, to analyze said images and to identify key features of the images received and relating to specific elements of the heavy element 300 to be lifted, and wherein said image processing device 418 is configured to determine, in respect of said first grabbing mechanism 8 and said second grabbing mechanism 10, whether or not said grabbing mechanism is located offset to a lifting anchor 302 of said heavy element 300, relative to said X direction and/or to said Z direction, and if so, wherein said control interphase 404 is configured to provide signals to one or more of: said first beam actuator 36; said second beam actuator 44 and said support leg actuator(s) 88 of said lifting yoke, in order to automatically make said first clutch 12 and/or said second clutch 16 approach the corresponding lifting anchor 302 of said heavy element 300.

Hereby, at least semi-automated orientation for the grabbing mechanisms 8,10 and/or of the support legs 68a,68b, relative to the lifting anchors 302 of the heavy element 300, prior to lift, can be obtained

In one embodiment of the lifting yoke of the first aspect of the present invention the key features of the images received and identified by said image processing device 418 relate to one or more of the following features: said lifting anchor 302 of said heavy element 300; a rim of said heavy element 300, an edge of said heavy element 300, a surface of said heavy element 300.

In one embodiment of the lifting yoke of the first aspect of the present invention the analysis being performed by said image processing device 418 is being based on patch features, such as colour distinction, edge detection, morphology, entropy of image patches making up such images.

In one embodiment of the lifting yoke of the first aspect of the present invention the data storage 424 comprises a representation of learning images, and wherein said image processing device 418 is being configured to consult said representation of learning images, wherein one or more of said images of said representation of learning images comprises a real image or an artificially generated image, such as a computer generated image, of an upper part of a heavy element, and wherein in respect of wherein one or more of said images of said representation of learning images has been allocated with information correlating said image with information relating to the position at said upper part of a heavy element corresponding to said image.

In one embodiment of the lifting yoke of the first aspect of the present invention the image processing device 418 is configured for employing deep learning algorithms and/or artificial intelligence and/or neural network in analyzing and in identifying said key features of the images received and relating to specific elements of the heavy element 300 to be lifted.

In a second aspect the present invention relates to a use of a lifting yoke 200 according to the first aspect of the present invention for lifting a heavy element.

In one embodiment of the use of the lifting yoke of the second aspect of the present invention, the lifting element is having a weight of 100 kg or more, such as 250 kg or more, for example 500 kg or more, such as 1,000 kg ore more, e.g. 2,000 kg or more, or even 5,000 kg or more, or 10,000 kg or more.

In one embodiment of the use of the lifting yoke of the second aspect of the present invention, the lifting element is being a concrete element, such as a building element for a structure, such as a wall element; or an element for a wind turbine, such as a wind turbine blade or a tower section of a wind turbine, a silo or a section of a silo; or a freight container.

In a third aspect the present invention provides a method for lifting a heavy element 300 of the type having two or more lifting anchors 302 exposed at an edge 304 thereof; said method comprises the following step;
i) providing a lifting yoke 200 according to the first aspect of the present invention;
ii) providing said heavy element 300 to be lifted in an orientation in which said lifting anchors 302 are positioned at an upper edge 304 thereof;
iii) arranging said lifting yoke 200 above said heavy element 300 in an orientation essentially corresponding to a plane defined by said heavy element;
iv) approaching said lifting yoke 200 to said heavy element 300;
v) remotely enabling said first clutch 12 of said first grabbing mechanism 8 to engage with a first lifting anchor 302 of said heavy element 300, and remotely enabling said second clutch 16 of said second grabbing mechanism 10 to engage with a second lifting anchor 302 of said heavy element 300;
vi) lifting said lifting yoke 200, such as by a lifting boom of a crane, and thereby also lifting said heavy element 300.

In one embodiment of the method of the third aspect of the present invention said lifting yoke 200 is a lifting yoke comprising support legs 68a,68b, wherein step iv) comprises the following steps:
iva) approaching said lifting yoke 200 to said heavy element 300; and
ivb) aligning said lifting yoke 200 relative to the orientation of said heavy element 300 by making said support surface 76,76a, 76b of said support element 74 of said one or more support legs 68a,68b abut an upper surface or edge 304 of said heavy element 300.

In a fourth aspect the present invention provides a method for moving a heavy element 300 of the type having two or more lifting anchors 302 exposed at an edge thereof from one location to another location, said method comprises the steps of:
a) performing steps i) to vi) of the method according to claim 200 or 201;
b) once lifted; moving the location of said heavy element 300, such as by moving the crane or the lifting boom thereof, to a new location;
c) lowering the lifting yoke 200, and thereby also lowering said heavy element 300, thereby making said heavy element 300 rest on a support at said new location;
d) remotely enabling said first clutch 12 of said first grabbing mechanism 8 to disengage with said first lifting anchor 302 of said heavy element 300, and remotely enabling said second clutch 16 of said second grabbing mechanism 10 to disengage with said second lifting anchor 302 of said heavy element 300;
e) moving said lifting yoke 200 from said new location.

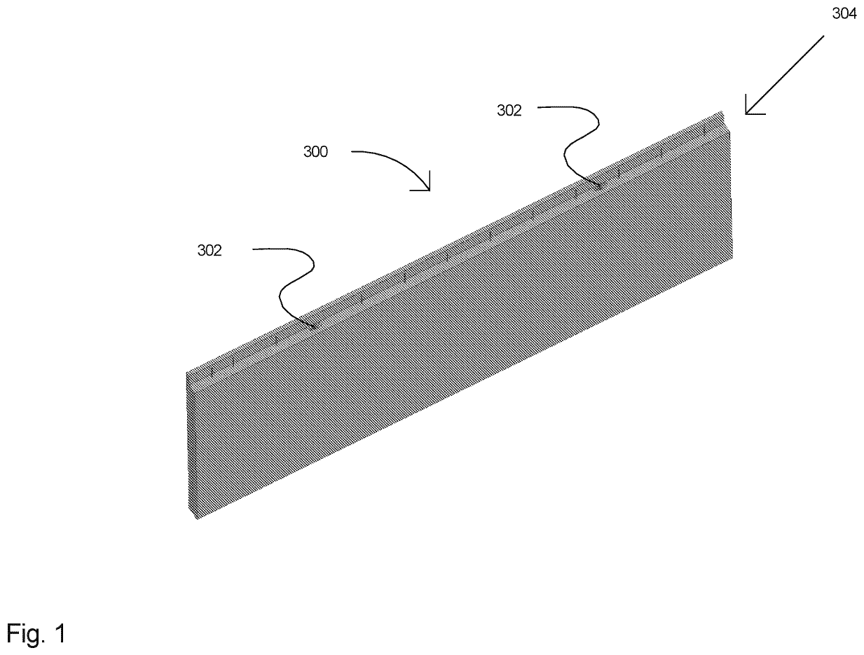

Referring now to the figures for better illustrating the present invention, FIG. 1 is a perspective view illustrating a heavy element in the form of a concrete wall element.

FIG. 1 shows the heavy element 300 in the form of a wall element made of concrete and comprising a body having an upper edge or rim 304. At the upper edge is exposed two lifting anchors 302 which in their lower end are being embedded in the concrete body. The two lifting anchors 302 are used for lifting and moving the concrete element 300 from one location to another.

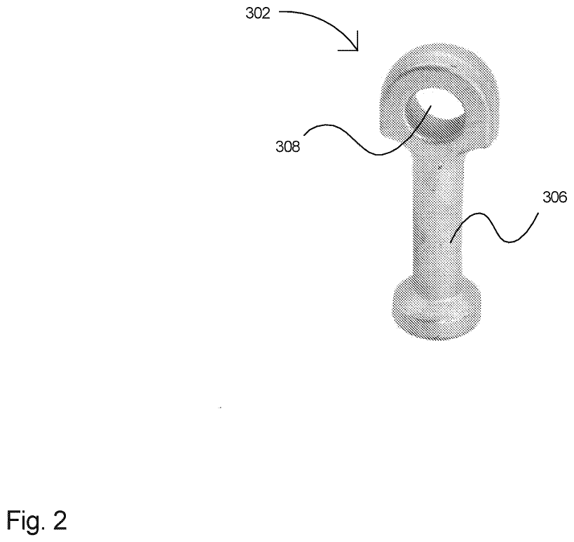

FIG. 2 is a photograph showing a perspective view of a typical type of a lifting anchor which are being used for embedding into a body of a concrete wall element.

The lifting anchor 302 comprises a stem 306 comprising a throughgoing opening 308. Only the lower part of the stem 306 is being embedded in the concrete body, thus exposing the upper part with the throughgoing opening 308. According to the prior art, the throughgoing opening is used for manually attaching a lifting hook or the like prior to a lift of a wall element comprising that lifting anchor.

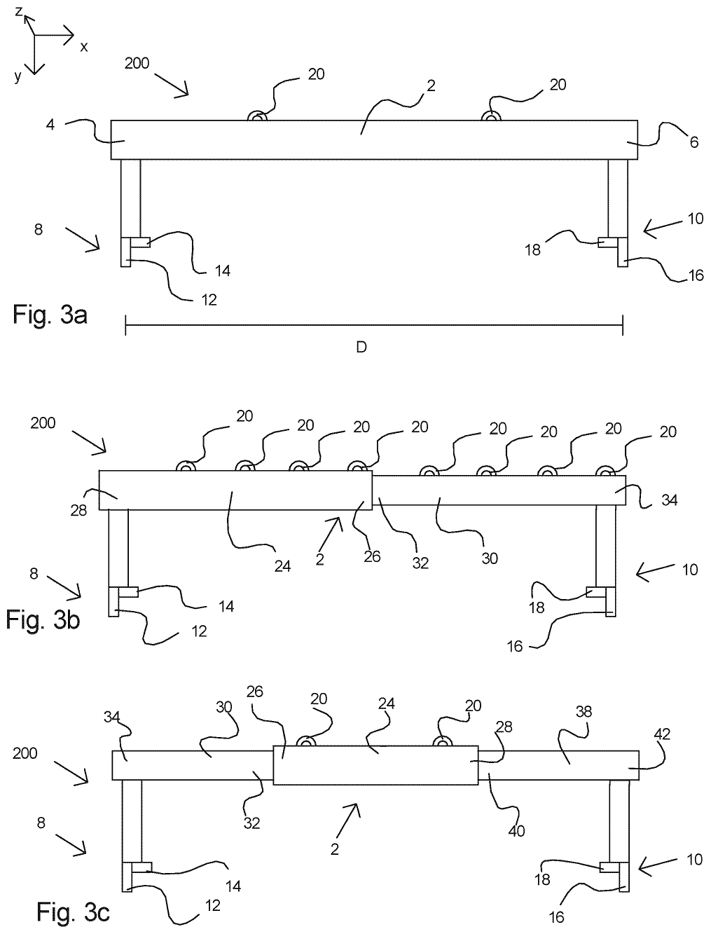

FIGS. 3a-3c are diagrammatic plane views illustrating the working principle of a lifting yoke according to the first aspect of the present invention.

FIG. 3a illustrates a general embodiment of the lifting yoke of the first aspect of the present invention. FIG. 3a shows the lifting yoke 200 comprising a horizontally arranged beam 2 having an extension in a longitudinal direction X between a first extreme end 4 and a second extreme end 6.

The lifting yoke comprises a first grabbing mechanism 8 and a second grabbing mechanism 10.

It is seen that the first grabbing mechanism 8 is being connected to the horizontally arranged beam 2 and that it comprises a a first clutch 12. The first clutch is configured to be able to shift between an engaged configuration for engagement with a lifting anchor 302 of a heavy element 300, and a disengaged configuration for disengaging with that lifting anchor 302, and vice versa.

The first clutch 12 comprises a first clutch actuator 14, which is being configured for enabling remote control of the configuration of the first clutch 12.

In a similar way, the second grabbing mechanism 10 is also connected to the horizontally arranged beam 2 and is comprising a second grabbing mechanism 10 comprising a second clutch 16 which is configured to be able to shift between an engaged configuration for engagement with a lifting anchor 302 of a heavy element 300 and a disengaged configuration for disengaging with that lifting anchor 302, and vice versa.

The second clutch 16 comprises a second clutch actuator 18, which is configured for enabling remote controlling of the configuration of the second clutch 16.

It is seen that the first clutch 12 and the second clutch 16 are being arranged at mutual distance D.

Also seen in FIG. 3a is that the horizontally arranged beam 2 of the lifting yoke 200 comprises two attachment means 20 for attachment of a lifting chain/wire 22 to be connected to a lifting boom of a crane (not seen in FIG. 3a).

By providing the lifting yoke 200 with the first remotely controlled clutch 12 and the second remotely controlled clutch 16 the need for a worker climbing a ladder in order to manually attach and/or detach lifting hooks to a heavy element to be lifted can be avoided. Thereby making a lifting operation more safe and more efficient.

The embodiment illustrated in FIG. 3a is useful for lifting and moving heavy elements comprising lifting anchors which pair-wise are arranged at a fixed and predetermined mutual distance.

FIG. 3b illustrates an improved embodiment of the lifting yoke of the first aspect of the present invention, relative to the embodiment illustrated in FIG. 3a.

FIG. 3b shows a lifting yoke 200. In this embodiment the horizontally arranged beam 2 comprises a main beam 24 having a first end 26 and a second end 28, and a first auxiliary beam 30 having a first end 32 and a second end 34.

The first auxiliary beam 30 is being attached to the main beam 24 at the first end 26 thereof in such a way that the first auxiliary beam 30 is being displaceable, in the longitudinal direction (X), relative to the main beam 24.

It is seen in FIG. 3b that the first grabbing mechanism 8 is being connected to the main beam 24, and that the second grabbing mechanism 10 is being connected to the first auxiliary beam 30.

In the embodiment illustrated in FIG. 3b the main beam 24, at a first end 26 thereof, is being hollow, and the auxiliary beam 30 is being arranged in the interior of that hollow first end 26 of the main beam 24.

The lifting yoke 200 comprises a first beam actuator 36 which is configured for adjusting the position of displacement, in the longitudinal direction X, of the first auxiliary beam 30, relative to said main beam 24 (not seen in FIG. 3b).

FIG. 3b further illustrates that the horizontally arranged beam 2 comprises a multitude of attachment means 20 arranged along the longitudinal extension X of that beam. Thereby the wall element may be balanced in its lift by choosing two more or less symmetrically arranged attachment means 20 for lifting.

FIG. 3c illustrates yet an improved embodiment of the lifting yoke of the first aspect of the present invention, relative to the embodiment illustrated in FIG. 3a and FIG. 3b.

FIG. 3c shows the lifting yoke 200 comprising a main beam 24 having a first end 26 and a second end 28; a first auxiliary beam 30 having a first end 32 and a second end 34; and a second auxiliary beam 38 having a first end 40 and a second end 42.

The first auxiliary beam 30 is being attached to the main beam 24 at the first end 26 thereof in such a way that the first auxiliary beam 30 is being displaceable, in the longitudinal direction (X), relative to the main beam 24.

Likewise, the second auxiliary beam 38 is being attached to the main beam 24 at the second end 28 thereof in such a way that the second auxiliary beam 38 is being displaceable, in the longitudinal direction (X), relative to the main beam 24.

It is seen in FIG. 3c that the first grabbing mechanism 8 is being connected to the first auxiliary beam 30, and that the second grabbing mechanism 10 is being connected to the second auxiliary beam 38.

In the embodiment illustrated in FIG. 3c the main beam 24, at a first end 26 thereof is being hollow, and the first auxiliary beam 30 is being arranged in the interior of that hollow first end 26 of the main beam 24, Moreover, the main beam 24, at a second end 28 thereof is being hollow, and the second auxiliary beam 38 is being arranged in the interior of that hollow second end 28 of the main beam 24.

The lifting yoke 200 of FIG. 3c comprises a first beam actuator 36 configured for adjusting the position of displacement, in the longitudinal direction X, of the first auxiliary beam 30, relative to said main beam 24 (not seen in FIG. 3c).

In analogy, the lifting yoke 200 of FIG. 3c comprises a second beam actuator 44 which is configured for adjusting the position of displacement, in the longitudinal direction X, of the second auxiliary beam 38, relative to said main beam 24 (not seen in FIG. 3c).

The first beam actuator 36 and optionally also the second beam actuator 44 is/are being configured for remote controlling thereof.

Hereby, it is possible with the lifting yoke 200 illustrated in FIGS. 3b and 3c to adapt to and engage with two lifting anchors of wall elements for a structure, wherein the mutual distance between these two lifting anchors varies from one wall element to another wall element.

The principle of having a center main beam and two auxiliary side beams as illustrated in FIG. 3c is preferred because this embodiment allows for easier balancing the lifting yoke with a connected heavy element in a lifting operation.

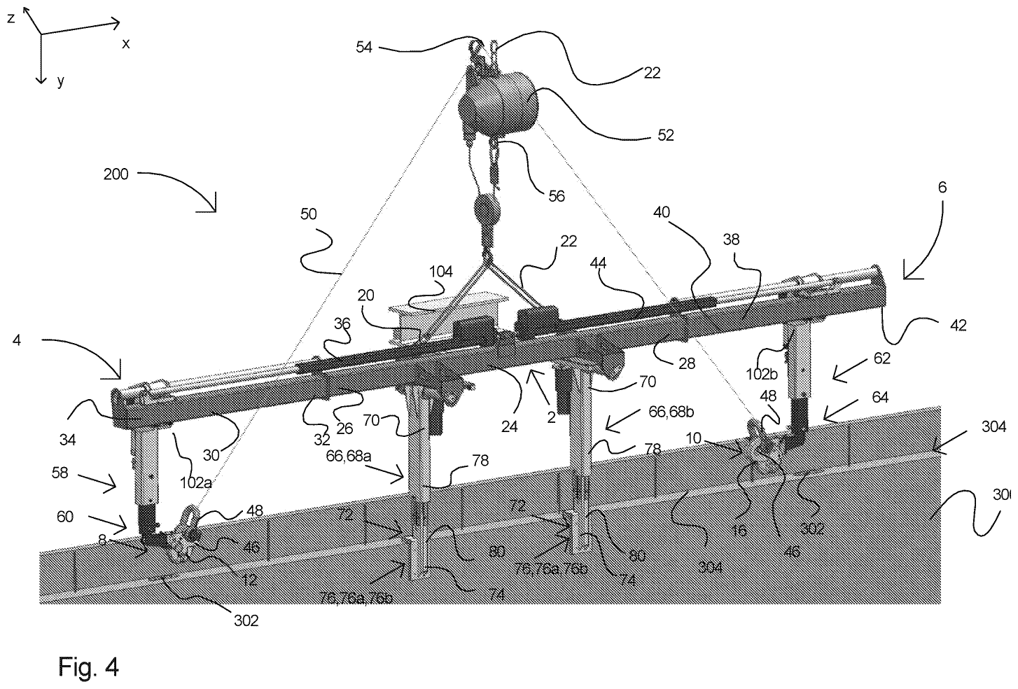

FIG. 4 is a drawing illustrating a perspective view of a lifting yoke according to the present invention and corresponding to the principle illustrated in FIG. 3c.

However, in the embodiment in FIG. 4, it is the grabbing mechanism themselves rather than the auxiliary beams that are displaceable along the horizontally arranged beam as explained below.

FIG. 4 shows the lifting yoke 200 comprising a main beam 24 having a first end 26 and a second end 28; a first auxiliary beam 30 having a first end 32 and a second end 34; and a second auxiliary beam 38 having a first end 40 and a second end 42.

The first auxiliary beam 30 is being fixed to the main beam 24 at said first end 26 thereof and the second auxiliary beam 38 is being fixed to the main beam 24 at the second end 28 thereof.

It is seen that the first grabbing mechanism 8 is being connected to the first auxiliary beam 30 and that the second grabbing mechanism 10 is being connected to the second auxiliary beam 38.

The lifting yoke 200 of FIG. 4 comprises a first beam actuator 36 configured for adjusting the position of displacement, in the longitudinal direction X, of the first grabbing mechanism 8, relative to said horizontally arranged beam 2.

In analogy, the lifting yoke of FIG. 4 comprises a second beam actuator 44; configured for adjusting the position of displacement, in the longitudinal direction X, of the second grabbing mechanism 10, relative to said horizontally arranged beam 2.

It is seen in FIG. 4 that the first grabbing mechanism 8 is being connected to a first auxiliary beam 30 via a first distance element 58 and that the second grabbing mechanism 10 is being connected to a second auxiliary beam 38 via a second distance element 62.

The first beam actuator 36 and the second beam actuator 44 are linear actuators having two opposite ends. The one end of each actuator is fastened to the main beam 24 and the opposite end of each actuator is connected to the first grabbing mechanism 8, via said first distance element 58, and to the second grabbing mechanism 10, via said second distance element 62.

The first distance element 58 is connected to a first position at the horizontally arranged beam 2 in a downward pointing direction Y; and the first grabbing mechanism 8 is connected to the first distance element 58 at a lower portion 60 thereof.

The second distance element 62 is connected to a second position at the horizontally arranged beam 2 in a downward pointing direction Y; and the second grabbing mechanism 10 is connected to the second distance element 62 at a lower portion 64 thereof.

FIG. 4 also shows that the lifting yoke 200 comprises a support arrangement 66 for aiding in aligning the lifting yoke 200, relative to a heavy element 300, prior to a lifting operation.

The support arrangement 66 comprises two support legs 68a,68b each having a first end 70 and opposite second end 72. In respect of each of the two support legs 68a,68b, the support leg at its first end 70 is connected to the horizontally arranged beam 2,24 in such a way that the support leg 68a,68b extends in a downward direction Y. Each of the two support legs 68a,68b comprises at its second end 72 a support element 74 comprising a support surface 76 for abutting a heavy element 300 prior to lifting thereof.

In FIG. 4 each support leg 68a,68b comprises an upper leg part 78 and a lower leg part 80 wherein the upper leg part 78 is connected to the horizontally arranged beam 2 and the lower leg part 80 is configured to be displaceable, in a longitudinal direction Y thereof, in relation to the upper leg part 78 between an upper extreme position and a lower extreme position. As seen, it is the lower leg part 80, at a lower portion thereof, comprises the support element 74 comprising the support surface 76.

In respect of two support legs 68a,68b, the upper leg part 78 simply comprises hollow tube and the lower leg part 80 is being loosely arranged in the interior of that hollow tube. Thereby the lower leg part 80 is allowed to be displaceable within the interior of said upper leg part 78, and it only being acted upon by the force of gravity As seen, the support surface 76 comprises two mutually perpendicular partial surfaces 76a,76b which are configured to abut an edge 304 of the heavy element 300 upon alignment of the lifting yoke 200 relative to said heavy element 300 and prior to lifting thereof.

FIG. 4 shows that a balancing ballast 104 made of concrete is arranged on the main beam 24 for counteracting any tilting of the lifting yoke 200 out of the XY-plane upon lifting.

FIG. 4 shows that the first grabbing mechanism 8 and said second grabbing mechanism 10 each comprises a fastening element 46 in the form of a throughgoing hole thereof. This is for fastening a shackle 48 thereto.

Thereby a stress reducing chain/wire 50 having in each of its ends a shackle 48 can be mounted to the fastening element 46 (the throughgoing hole) of the first grabbing mechanism 8 and of said second grabbing mechanism 10, respectively. As seen, the stress reducing chain/wire 50 is connected to the lifting chain/wire which, by means of a lifting boom of a crane, is configured for lifting the lifting yoke 200. Hereby, stress encountered by the first grabbing mechanism 8 and the second grabbing mechanism 10 due to the weight being lifted, is highly reduced.

This is brought about by arranging a “zero gravity” balancing device 52 in the form of a spring-loaded balancing device, having an upper attachment point 54 for an upper hoist and a lower attachment point 56 for a lower hoist.

As seen, the upper attachment point 54 is connected to a lifting chain/wire for lifting by a lifting boom of a crane, and the lower attachment point 56 is connected to two attachment means 20 of the lifting yoke 200 in such a way that the stress reducing chain/wire 50 is connected to the lifting chain/wire to be lifted by a lifting boom of a crane.

With this set-up, stresses on the first grabbing mechanism 8 and on said second grabbing mechanism 10 can be reduced irrespective of the position of the first grabbing mechanism 8 and the second grabbing mechanism 10, respectively, relative to the horizontally arranged beam 2.

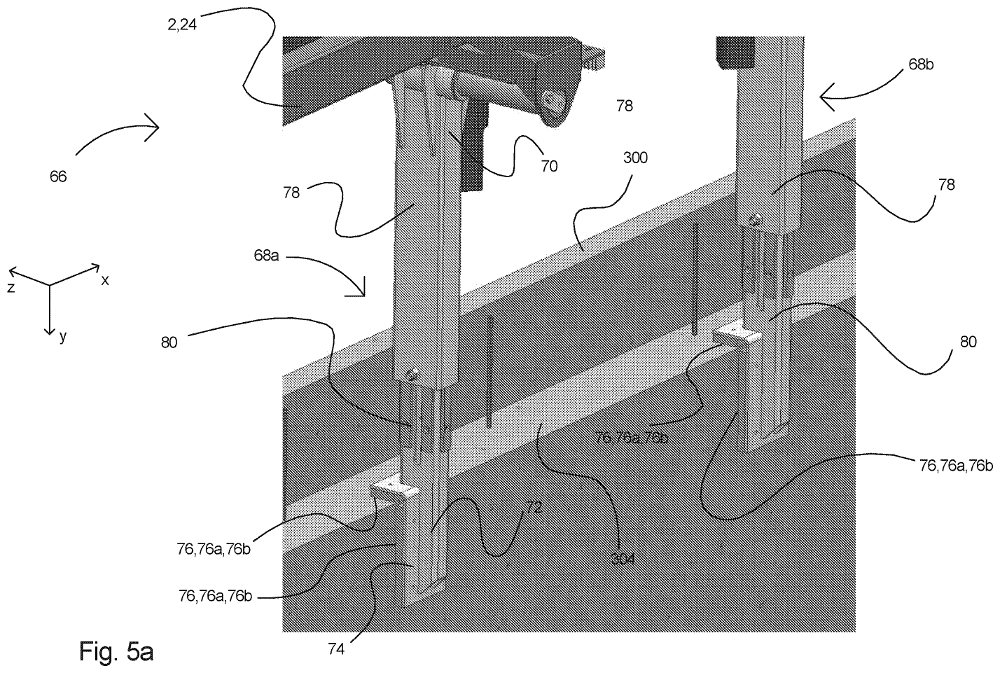

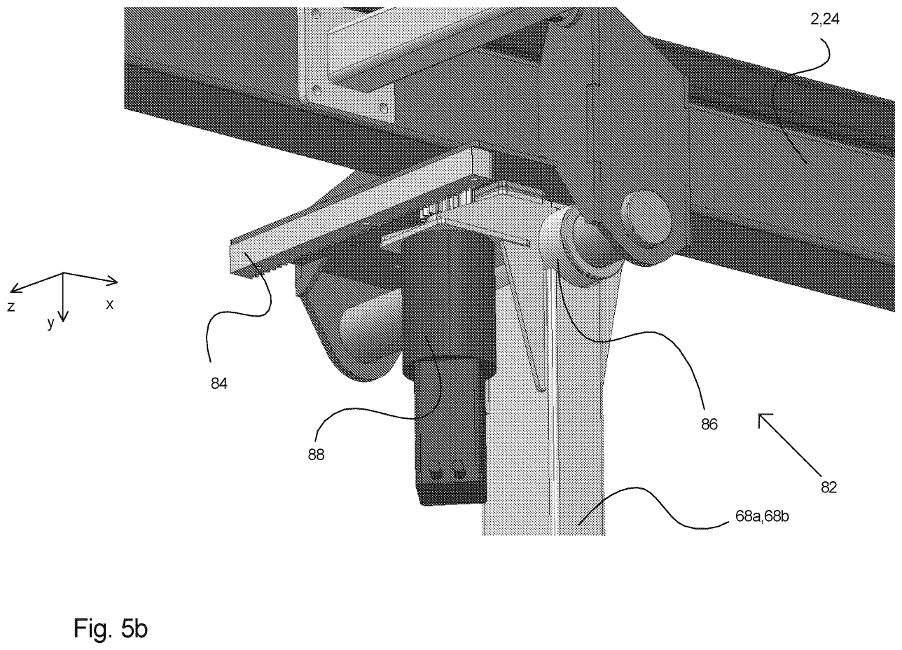

Each of the two support legs 68a,68b are configured to be displaceable, relative to horizontally arranged beam 2 of the lifting yoke in a direction Z which is perpendicular to the X direction and to the Y direction. This is described in more detail below with reference to FIGS. 5a and 5b.

The support legs 68a,68b serve the purpose of enabling alignment of the lifting yoke 200 to the orientation of the heavy element 300 prior to engaging the first clutch 12 and the second clutch 16 to two lifting anchors 302 of that heavy elements 300, and hence also prior to lifting of the heavy element 300.

This alignment operation is performed by approaching, via a lifting boom of a crane, the lifting yoke 200 to a heavy element 300 which is to be lifted, and by making sure that the support surface 76 of each of the support legs abut a surface, such as an edge or rim 304 of the heavy element 300. Once this has been attained, the lifting yoke is free to be raised or lowered relative to the heavy element because a lower leg part 80 of the support leg 68a,68b is free to move inside the upper leg part 78 of the support leg 68a,68b.

Accordingly, once being aligned with the orientation of the heavy element 300, the lifting yoke 200 can be further lowered on order for the first clutch 12 and the second clutch 16 of the first and second grabbing mechanisms 8,10, respectively to reach the level, in a vertical position, of two lifting anchors 302 of that heavy element 300. Once this level has been reached, the first clutch 12 and the second clutch 16 of the first and second grabbing mechanisms 8,10 can be engaged so as to be locked to the two lifting anchors 302 of the heavy element.

FIG. 5a is a drawing illustrating in a close-up perspective view, details of the support arrangement of the lifting yoke.

FIG. 5a shows the support arrangement 66 comprising the two support legs 68a and 68b, each comprising an upper leg part 78 and a lower leg part 80. Each of the lower leg parts 80 are loosely arranged in the interior of the upper leg part 78, thereby, in a rest situation, only being acted upon by the force of gravity.

It is seen in FIG. 5a that the lower leg part 80 of each of the two legs 68a,68b comprising two mutually perpendicular support surfaces 76,76a, 76b which are arranged to abut the edge 304 of the heavy element 300, hereby aiding in aligning the lifting yoke 200 relative to the orientation of the heavy element 300 prior to lifting thereof.

Now it may happen that the position of each of the first clutch 12 and the second clutch 16 of the first and second grabbing mechanisms 8,10, respectively do not align with the position of the two lifting anchors 302 of the heavy element in in Z direction (which is perpendicular) to the X and to the Y direction).

In order to circumvent this problem, each support leg 68a,68b may be provided with means for moving the legs 68a,68b in the Z-direction. This is explained further with reference to FIG. 5b.

FIG. 5b is a drawing illustrating in a close-up perspective view a support leg suspension 82 for suspending a support leg 68a,68b to the horizontally arranged beam 2, 24 of the lifting yoke of the first aspect of the invention.

FIG. 5b shows the support leg suspension 82 comprising a support leg rail 84 having an extension in a direction (Z), which is essentially perpendicular to said horizontal direction (X) and to said vertical direction (Y). The support leg rail 84 is connected to the horizontally arranged beam 2 comprising the main beam 24. The support leg suspension 82 additionally comprises a displacement element 86 which is being coupled to the support leg rail 84.

The support leg suspension 82 furthermore comprises a support leg actuator 88 which is configured for adjusting the position of the displacement element 86, and thereby also of the support leg 68a,68b, relative to the support leg rail 84 and thereby also relative to the horizontally arranged beam 2 (and the main beam 24) and along said direction (Z).

The support leg actuator 88 is configured to be remotely controlled.

Hereby, the displacement element 86 is configured to be able to be displaced along the extension of said support leg rail 84 along the direction (Z) thereof.

In FIG. 5b the support leg rail 84 comprises a toothed rack and the support leg actuator 88 comprises an electromotor having a gear on its rotational axle that engages with this toothed rack.

By actuating the electromotor so that the gear rotates in one rotational direction or the other, this rotation of the gear will make the displacement element 86 and thereby also the support leg 68a,68b move a distance along the Z direction. Hereby the support leg 68a,68b will be moved in a Z-direction relative to the horizontally arranged beam 2 (and also the main beam 24).

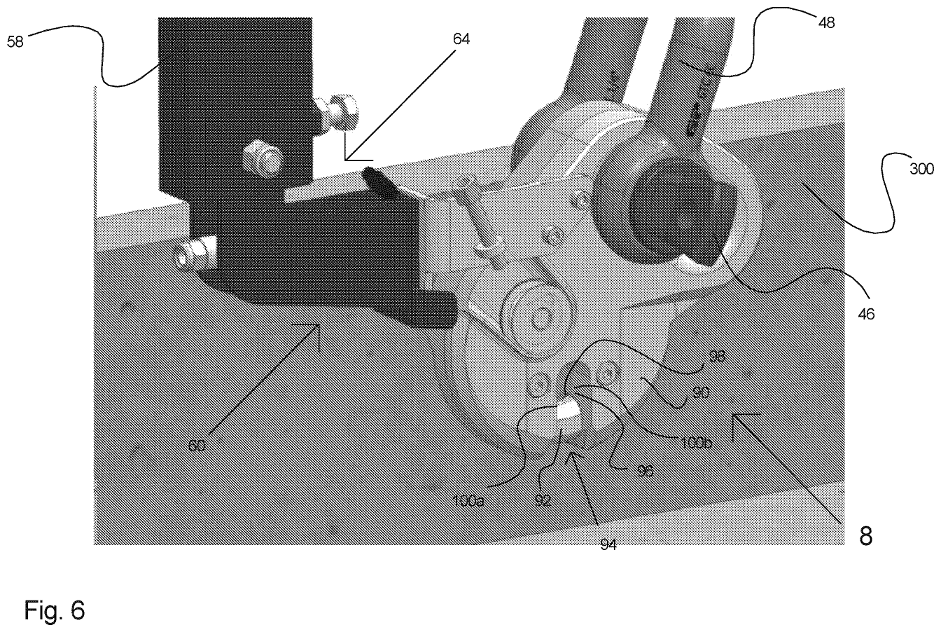

FIG. 6 is a close-up drawing showing details relating to the position of the first grabbing mechanism.

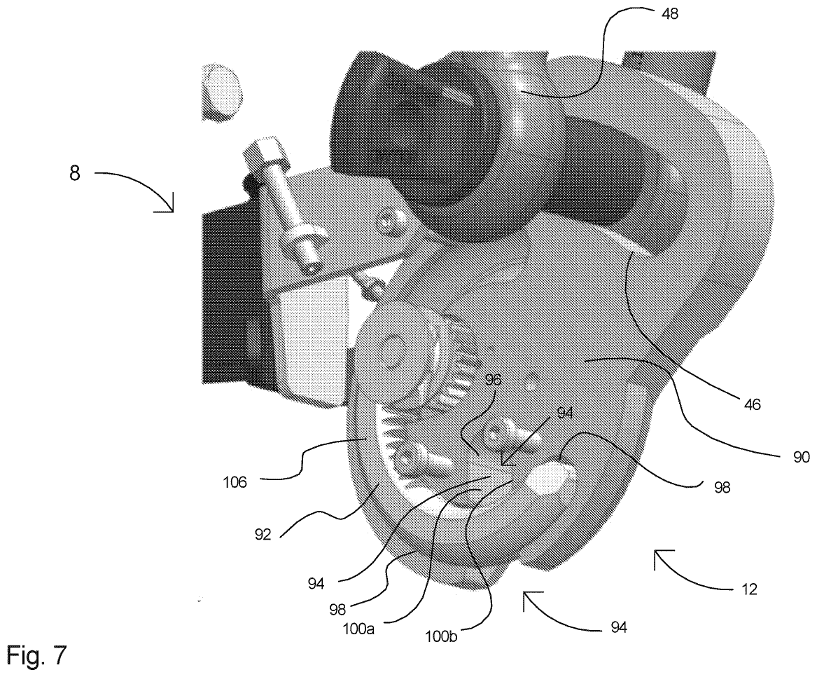

FIG. 6 shows the first grabbing mechanism 8 arranged at a lower portion 60 of the first distance element 58. The first grabbing mechanism 8 comprises the first clutch 12 as described below with reference to FIG. 7.

FIG. 7 is close-up drawing showing internal details of the first clutch.

FIG. 7 shows that the first grabbing mechanism 8 comprises a first clutch 12.

The first clutch 12 comprises a body 90 and a locking element 92. The body 90 comprises an oblong recess 94.

The oblong recess 94 defines an inner wall 96. The body 90 furthermore comprises a locking element channel 98 which extends from opposite sides 100a, 100b of the inner wall 96 of the oblong recess 94 and into the body 90 in opposite directions.

The locking element 92 is being accommodated in this locking element channel 98.

Furthermore, the locking element 92 is configured, upon actuation thereof, to be slit in the locking element channel 98 between a retracted position and an expanded position, and vice versa.

In FIG. 7 the locking element is positioned in its expanded position, thereby blocking access into the oblong recess 94 of the body 90 from the outside.

As seen in FIG. 7 the looking element 92 comprises teeth at a portion of its inner circumference. A gear is positioned to enter into engagement with these teeth. Hence, by turning the gear in one rotational direction, the clutch 12 will shift configuration from a being in an expanded configuration to be in a retracted configuration, wherein the locking element 92 no longer will block the access of a lifting hook 302 of a heavy element 300.

Accordingly, the clutch 12 illustrated in FIG. 7 will be able to engage and to disengage with a lifting anchor 302 of a heavy element 300, when the lifting anchor 302 is of the type comprising an exposed stem 306 having a throughgoing opening 308 in it.

It is seen in FIG. 7 that the locking element 92 and the locking element channel 98 is having a circular extension, thereby making the locking element 92 perform an essential circular movement upon being slit in the locking element channel 98 between the retracted position and said expanded position, or vice versa.

Alternatively, the locking element channel 98 and the locking element 92 could have had a linear extension, thereby making the locking element 92 perform an essential linear movement upon being slit in the locking element channel 98 between the retracted position and said expanded position, or vice versa.

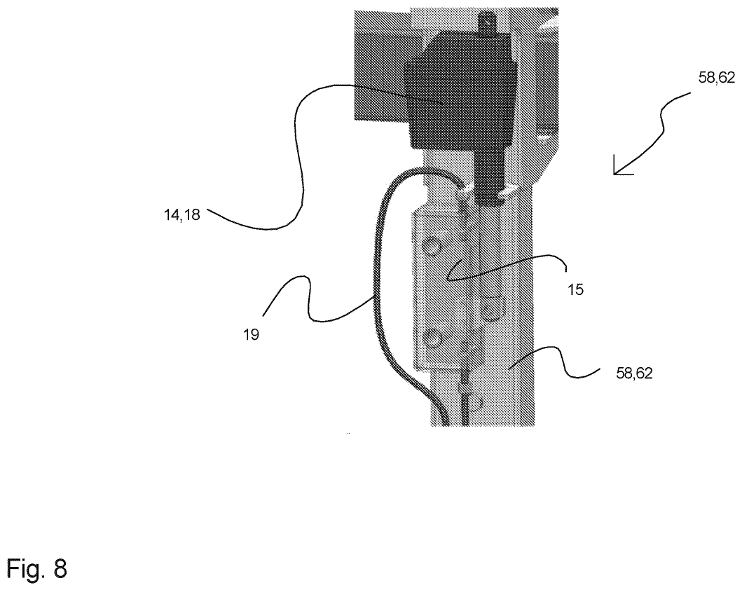

FIG. 8 is a drawing showing in a perspective view an embodiment of an actuator for engaging and disengaging the clutch of the first grabbing mechanism and the second mechanism.

FIG. 8 shows the distance element 58,62 associated with the first or the second grabbing mechanism 8,10, respectively.

It is seen that on the distance element 58,82 is arranged an actuator 14,18 for actuating the first clutch 12 of the first grabbing mechanism 8 or a second clutch 16 for actuating the second grabbing mechanism 10.

The actuation is brought about by the clutch actuator 14,18 which is being a linear actuator and which is being configured for displacing an inner wire 15 of a clutch actuation cable 19. The inner wire 15 is being connected to the locking element 92 of the clutch 12,16.

Hereby, the clutch actuator 14,18 may, by actuation thereof, make the locking element 92 perform displacement in the locking element channel 98 between the retracted position and said expanded position, or vice versa.

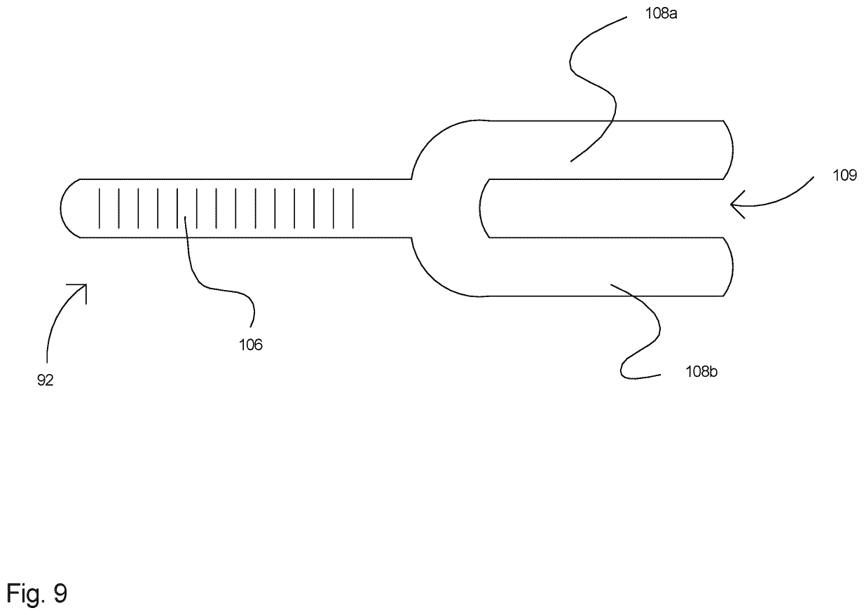

In an alternative embodiment of the clutch 12,16 the locking element 92 may have a fork like structure. This is further illustrated in FIG. 9.

FIG. 9 is a plane view illustrating the locking element of clutch of a grabbing mechanism of the lifting yoke.

FIG. 9 shows the locking element 92 comprising an elongate member 106 comprising in its one end a first prong 108a and a second prong 108b. Between these prongs an open space 109 is present. The open space 109 is configured for accommodating a stem 306 of a lifting anchor 302 of a heavy element to be lifted. In such a situation, the lifting anchor 302 is of the type comprising a stem 306 with a head 310 in its one end, wherein the head 310 is having an extension in a direction perpendicular to a longitudinal extension of said stem 306, which is larger than the extension of said stem 306 in that direction.

Hereby the two prongs 108a an 180b of the locking element 92 can be arranged, in a locking configuration, below that head 310 of the lifting anchor 302.

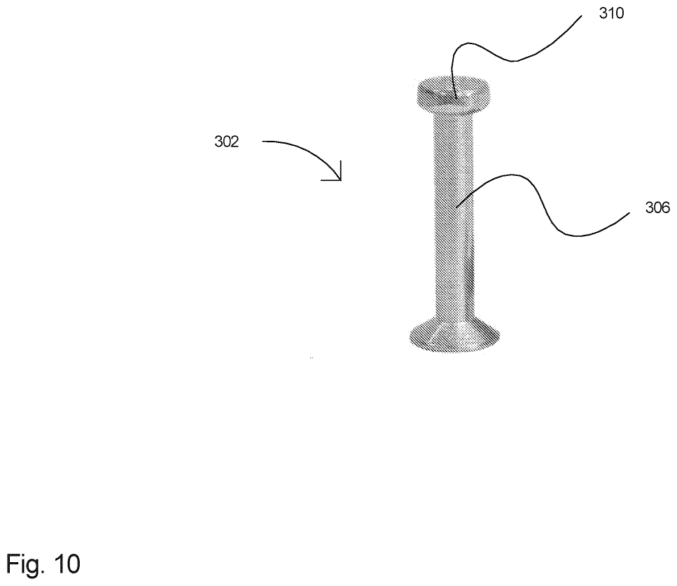

This type of lifting anchor is illustrated in FIG. 10.

FIG. 10 is a photograph illustrating an alternative type of a lifting anchor of a heavy element.

FIG. 10 shows that the lifting anchor 302 comprises a stem 306 with a head 310 in its one end. It is seen that the head 310 is having an extension in a direction perpendicular to a longitudinal extension of the stem 306, which is larger than the extension of the stem 306 in that direction.

Thereby the locking element 92 illustrated in FIG. 9 will be able to enter into engagement with the lifting element 302 shown in FIG. 10.

The body 90 of the clutch 12,16 or use with the embodiment of the locking element 92 illustrated in FIG. 9 may comprise the locking element channel 98 in the form of a common cavity for accommodating both of the two prongs 108a, 108b of the locking element 92.

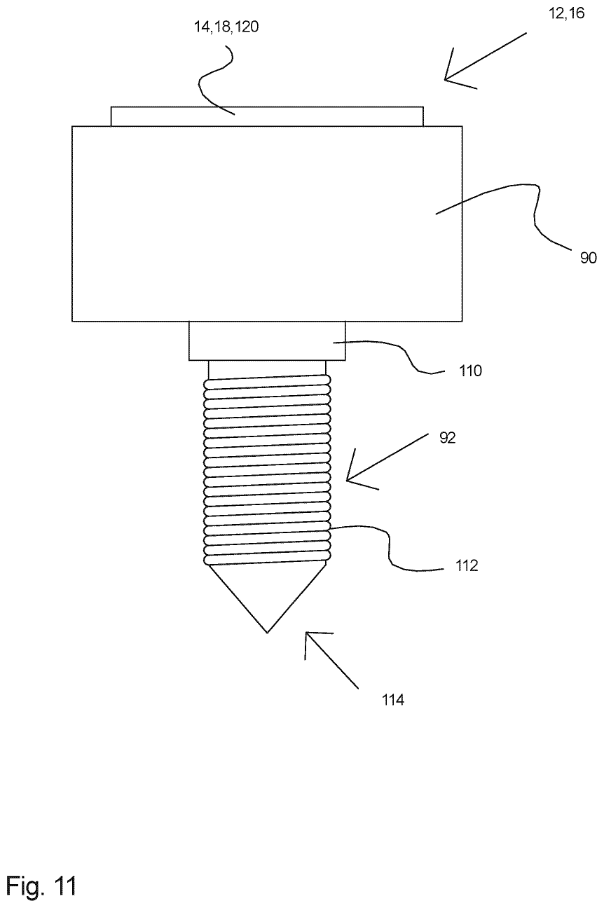

Alternatively, the locking element channel 98 of the body 90 of the clutch 12,16 comprises two separate cavities, wherein each of these two cavities are configured for accommodating its own individual prong of the two prongs 108a,108b. In an alternative embodiment of the clutch 12,16 of the lifting yoke, the clutch is configured for entering into engagement with a lifting anchor 302 of a building block 300 in the form of either an exposed female thread or an expose male thread. These embodiments are further illustrated with reference to FIGS. 11-14.

FIG. 11 is a plan view illustrating an alternative embodiment of the clutch of the lifting yoke according to the invention.

FIG. 11 shows that the clutch 12,16 comprises a body 90 and a locking element 92.

The body comprises the clutch actuator 14,18 in the form of an electric motor 120 having an axle 110 and the locking element 92 comprises a male thread 112 connected to that axle 110.

Hereby, the electric motor 120 is configured to rotate the axle 110 thereof in one or in another rotational direction upon remote controlling thereof. This enables engagement/disengagement of the clutch 12,16 with a lifting anchor 302 of a heavy element 300, in a situation wherein the lifting anchor 302 comprises an exposed female thread 312.

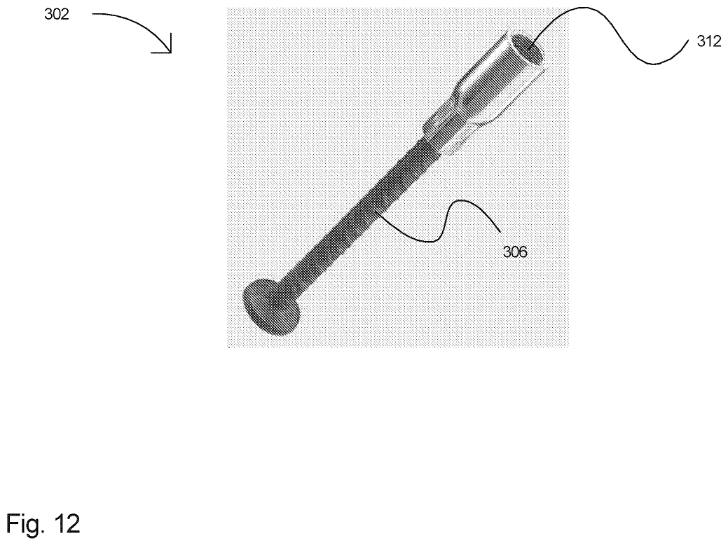

Such type of a lifting anchor is illustrated in FIG. 12.

FIG. 12 is a photograph illustrating an alternative type of a lifting anchor of a heavy element which comprises an expose female thread.

FIG. 12 shows the lifting anchor 302 comprising a stem 306 with an exposed female thread 312 in its one end.

It is seen in FIG. 11 that the male thread of the locking element 92 comprises a tapered end portion 114. This will aid in guiding the male thread 112 into the corresponding female thread 312 of the lifting anchor 302 illustrated in FIG. 12.

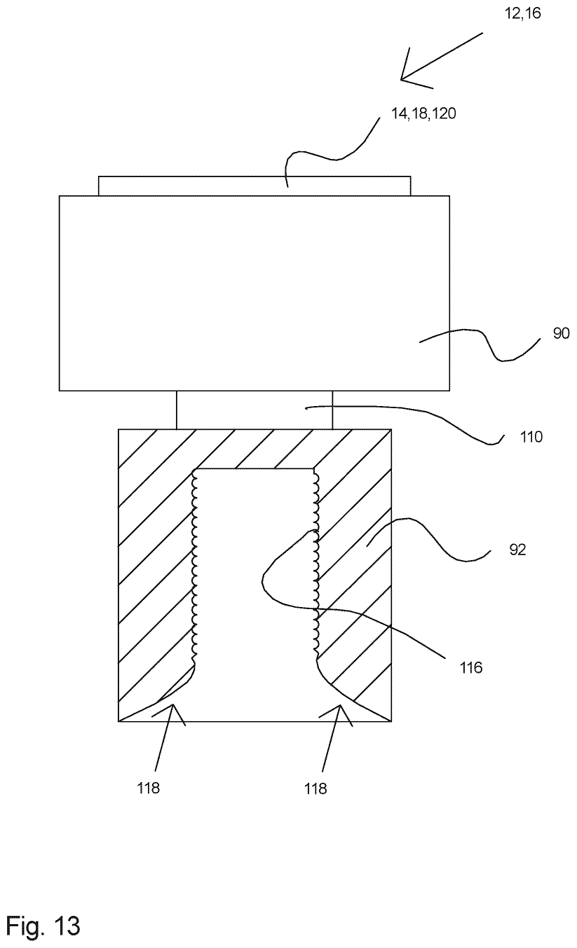

In yet another embodiment of clutch 12,16 of the grabbing mechanism 8,10 of the lifting yoke 200 of the present invention the locking element 92 comprises a female thread. This is further illustrated in FIG. 13

FIG. 13 is a partly cross-sectional view illustrating yet an alternative embodiment of the clutch of the lifting yoke according to the invention.

FIG. 13 shows that the clutch 12,16 comprises a body 90 and a locking element 92.

The body comprises the clutch actuator 14,18 in the form of an electric motor 120 having an axle 110 and the locking element 92 comprises a female thread 116 connected to that axle 110.

Hereby, the electric motor 120 is configured to rotate the axle 110 thereof in one or in another rotational direction upon remote controlling thereof. This enables engagement/disengagement of the clutch 12,16 with a lifting anchor 302 of a heavy element 300, in a situation wherein the lifting anchor 302 comprises an exposed male thread 314.

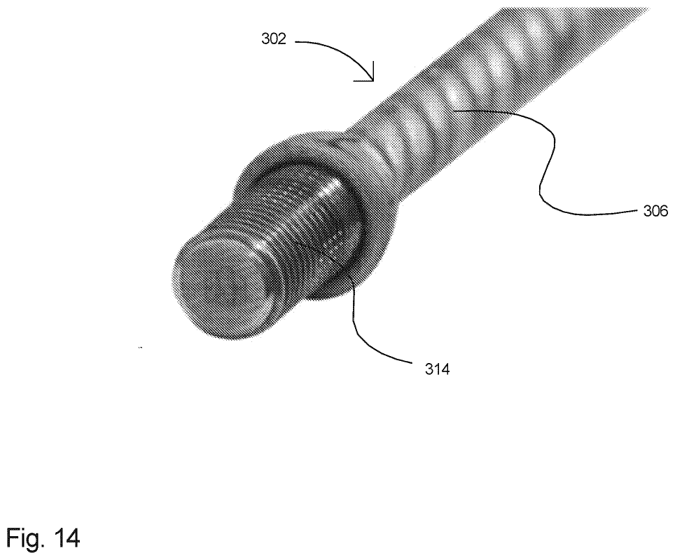

Such type of a lifting anchor is illustrated in FIG. 14.

FIG. 14 is a photograph illustrating such an alternative type of a lifting anchor of a heavy element which comprises an expose male thread.

FIG. 14 shows the lifting anchor 302 comprising a stem 306 with an exposed male thread 314 in its one end.

It is easily conceivable that a clutch 12,16 of the type illustrated in FIG. 13 will be able to enter into engagement with a lifting anchor 302 of a heavy element of the type illustrated in FIG. 14.

FIG. 13 shows that the female thread 116 at its end comprises a chute portion 118 for aiding in guiding said exposed male thread 314 of a lifting anchor 302 of a heavy element 300 into said female thread 116 of said clutch.

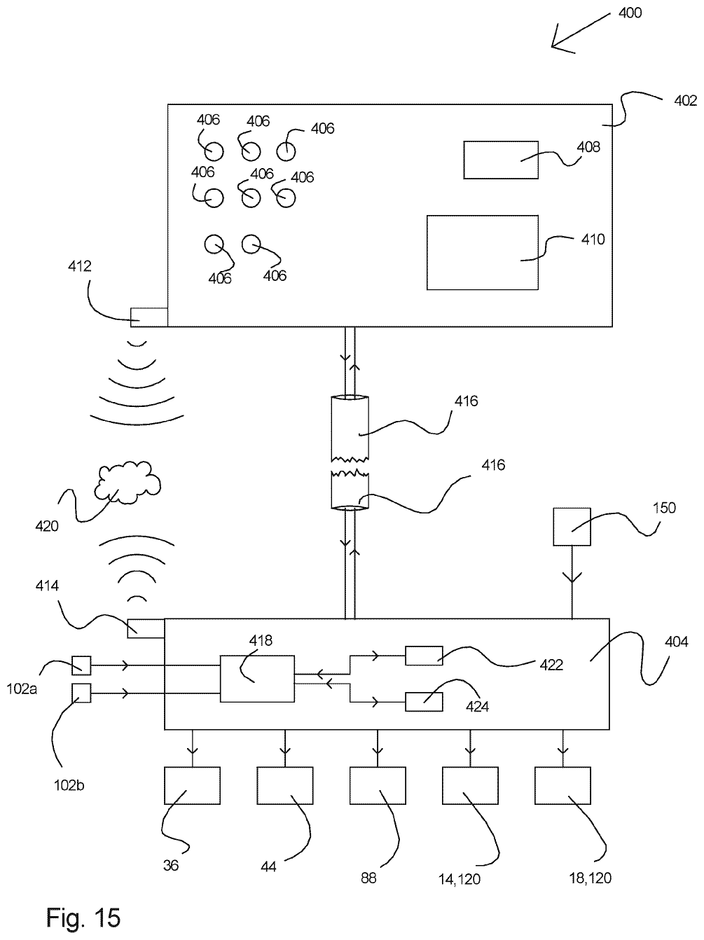

In order to control the operation of the lifting yoke 200 according to the first aspect of the present invention, a control system is provided. This is illustrated in FIG. 15.

FIG. 15 is a schematic diagram illustrating the working mode of the control system for controlling the lifting yoke of the present invention.

FIG. 15 shows the control system 400 for controlling the operation of the lifting yoke. The control system 400 comprises a control panel 402 for enabling an operator to provide input instructions for controlling the operation of said lifting yoke, and a control interphase 404.

The control panel 402 is being connected to the control interphase 404, thereby enabling conveying of operational instructions from the control panel 402 to the control interphase 404.

It is seen that the control interphase 404 is coupled to the first clutch actuator 14,120, to the second clutch actuator 18,120, to the support leg actuator(s) 88, and to the first beam actuator 36 and the second beam actuator 44, the image capturing devices 102a, 102b and the battery 150 of the lifting yoke 200.

Hence, the control interphase 404 will be able to translate the operational instructions received into signals, such as into power signals, for activating these various actuators and motors of the lifting yoke 200.

FIG. 15 shows that the control panel 402 comprising input means 406, in the form of one or more knobs, joysticks or the like for providing instructions by an operator.

Also seen is that the control panel 402 comprises a display 408 for displaying details relating to the operational status of said lifting yoke 200.

The control panel 402 also comprises a monitor 410 for displaying images captured by the image capturing devices 102a, 102b.

The control panel is preferably handheld and/or portable.

An image processing device 416 for processing images captured by said image capturing devices 102a, 102b is also included in the control interphase 404.

The control panel 402 and the control interphase 404 may be connected by a cable 416, thereby enabling wired controlling said lifting yoke 200 from said control panel 402.

Alternatively, the control panel 402 may communicate with the control interphase 404 wirelessly. This is brought about by providing the control panel 402 with a first wireless communication unit 412 operating via electromagnetic radiation, and by providing the control interphase with a second wireless communication unit 414 operating via electromagnetic radiation. The first wireless communication unit 412 and the second wireless communication unit 414 are configured to communicate with each other.

Hereby, wireless controlling of the lifting yoke 200 from the control panel 402 is enabled by wirelessly communicating operational instructions 420 from the control panel 402 and the control interphase 404.

In a similar way, images captured by the image capturing devices 102a, 102b may be wirelessly communicated to the monitor 410 of the control panel 402.

The control interphase 404 is intended for being arranged at or near said horizontally arranged beam 2 of said lifting yoke 200.

In an embodiment of the first aspect of the present invention the lifting yoke is configured for automatically alignment of the first clutch 12 and the second clutch 16, relative to the lifting anchors 302 of the heavy element. This is explained below.

In this embodiment the image processing device 416 of the control interphase 404 is being coupled to a central processing unit (CPU) 422 and a data storage 424.

The image processing device 418 is being configured, based on images received by said image capturing devices 102a,102b, to analyze the images and to identify key features of the images received. These key features relate to specific elements of the heavy element 300 to be lifted. Accordingly, such key features may relate to a lifting anchor 302 of the heavy element 300, rims of the heavy element 300, edges of the heavy element 300 or surfaces of the heavy element 300.

Based on the analysis performed by the image processing device 418 it is determined, in respect of the first grabbing mechanism 8 (and/or the associated first clutch 12) and the second grabbing mechanism 10 (and/or the associated second clutch 16), whether or not that grabbing mechanism is located offset, in an X direction and/or in a Z direction, to a lifting anchor 302 of the heavy element 300 to be lifted.

In case such offset location of the first grabbing mechanism 8 and the second grabbing mechanism 10 (or the associated clutches 12,16), relative to the lifting anchors 302 is present, the control interphase 404 is configured to provide signals to one or more of: the first beam actuator 36; the second beam actuator 44 and the support leg actuator(s) 88 of the lifting yoke with the view to automatically make that first clutch 12 and/or that second clutch 16 of the lifting yoke 200 approach the corresponding lifting anchor(s) 302 of the heavy element 300, in that X direction and/or in that Z direction.

The CPU 422 may be involved in performing such analysis.

The analysis being performed by the image processing device 418 may be based on patch features, such as colour distinction, edge detection, morphology, entropy of image patches making up such images analyzed.

The data storage 424 may comprise a representation of learning images, and the image processing device 418 is being configured to consult such representation of learning image.

One or more of the images of the representation of learning images may be real images or artificially generated images, such as computer-generated images, of an upper part of a heavy element.

It is preferred that one or more of the images of the representation of learning images has been allocated with information correlating that specific image with information relating to the position, at the upper part of a heavy element, corresponding to that image.

The image processing device 418 may be configured for employing deep learning algorithms and/or artificial intelligence and/or neural network in analyzing and in identifying said key features of the images received and relating to specific elements of the heavy element 300 to be lifted.

It should be understood that all features and achievements discussed above and in the appended claims or clauses in relation to one aspect of the present invention and embodiments thereof apply equally well to the other aspects of the present invention and embodiments thereof.

The present invention may be defined according to one or more of the following clauses:
Clause 1. A lifting yoke (200) for lifting a heavy element (300); said heavy element being of the type comprising a body having two or more lifting anchors (302) exposed at an edge (304) thereof;
wherein said lifting yoke (200), in the orientation intended during lifting, comprises:
   a horizontally arranged beam (2) having an extension in a longitudinal direction (X) between a first extreme end (4) and a second extreme end (6);
   a first grabbing mechanism (8);
   a second grabbing mechanism (10);
wherein said first grabbing mechanism (8) is being connected to said horizontally arranged beam (2) and is comprising a first clutch (12) which is being configured to be able to shift between an engaged configuration for engagement with a lifting anchor (302) of a heavy element (300), and a disengaged configuration for disengaging with said lifting anchor (302), and vice versa, wherein said first clutch (12) comprises a first clutch actuator (14), which is being configured for enabling remote controlling of the configuration of said first clutch (12);
wherein said second grabbing mechanism (10) is being connected to said horizontally arranged beam (2) and is comprising a second clutch (16) which is being configured to be able to shift between an engaged configuration for engagement with a lifting anchor (302) of a heavy element (300) and a disengaged configuration for disengaging with said lifting anchor (302), and vice versa, wherein said second clutch (16) comprises a second clutch actuator (18) which is being configured for enabling remote controlling of the configuration of said second clutch (16);
wherein said first clutch (12) and said second clutch (16) are being arranged at mutual distance (D);
wherein said lifting yoke (200) comprises one or more attachment means (20) for attachment of a lifting chain/wire (22) to be connected to a lifting boom of a crane.
Clause 2. A lifting yoke (200) according to clause 1, wherein said horizontally arranged beam comprises:
   a main beam (24) having a first end (26) and a second end (28); and
   a first auxiliary beam (30) having a first end (32) and a second end (34);
wherein said first auxiliary beam (30) is being attached to said main beam (24) at said first end (26) thereof in such a way that said first auxiliary beam (30) is being displaceable, in said longitudinal direction (X), relative to said main beam (24);
wherein said first grabbing mechanism (8) is being connected to said main beam (24); and
wherein said second grabbing mechanism (10) is being connected to said first auxiliary beam (30).
Clause 3. A lifting yoke (200) according to clause 2, wherein said main beam (24), at least at a first end (26) thereof is being hollow, and wherein said first auxiliary beam (30) is being arranged in the interior of said hollow first end (26) of said main beam (24).
Clause 4. A lifting yoke (200) according to clause 2 or 3 wherein said lifting yoke comprises a first beam actuator (36); wherein said first beam actuator is being configured for adjusting the position of displacement, in said longitudinal direction (X), of said first auxiliary beam (30), relative to said main beam (24).
Clause 5. A lifting yoke 200 according to clause 1, wherein said horizontally arranged beam comprises:
   a main beam (24) having a first end (26) and a second end (28); and
   a first auxiliary beam (30) having a first end (32) and a second end (34);
   a second auxiliary beam (38) having a first end (40) and a second end (42);
wherein said first auxiliary beam (30) is being attached to said main beam (24) at said first end (26) thereof in such a way that said first auxiliary beam (30) is being displaceable, in said longitudinal direction (X), relative to said main beam (24);
wherein said second auxiliary beam (38) is being attached to said main beam (24) at said second end (28) thereof in such a way that said second auxiliary beam (38) is being displaceable, in said longitudinal direction (X), relative to said main beam (24);
wherein said first grabbing mechanism (8) is being connected to said first auxiliary beam (30); and
wherein said second grabbing mechanism 10 is being connected to said second auxiliary beam (38).
Clause 6. A lifting yoke (200) according to clause 5, wherein said main beam (24), at least at a first end (26) thereof is being hollow, and wherein said first auxiliary beam (30) is being arranged in the interior of said hollow first end (26) of said main beam (24); and
wherein said main beam (24), at least at a second end (28) thereof is being hollow, and wherein said second auxiliary beam (38) is being arranged in the interior of said hollow second end (28) of said main beam (24).
Clause 7. A lifting yoke (200) according to clause 5 or 6, wherein said lifting yoke comprises a first beam actuator (36); wherein said first beam actuator (36) is being configured for adjusting the position of displacement, in said longitudinal direction (X), of said first auxiliary beam (30), relative to said main beam (24); and
wherein said lifting yoke comprises a second beam actuator (44); wherein said second beam actuator is being configured for adjusting the position of displacement, in said longitudinal direction (X), of said second auxiliary beam (38), relative to said main beam (24).
Clause 8. A lifting yoke 200 according to clause 1, wherein said first grabbing mechanism (8) is being connected to said horizontally arranged beam (2) in such a way that said that said first grabbing mechanism (8) is being displaceable, in said longitudinal direction (X), relative to said horizontally arranged beam (2); and/or wherein said second grabbing mechanism (10) is being connected to said horizontally arranged beam (2) in such a way that said that said second grabbing mechanism (10) is being displaceable, in said longitudinal direction (X), relative to said horizontally arranged beam (2).
Clause 9. A lifting yoke 200 according to clause 8, wherein said horizontally arranged beam (2) comprises:
   a main beam (24) having a first end (26) and a second end (28); and
   a first auxiliary beam (30) having a first end (32) and a second end (34);
   a second auxiliary beam (38) having a first end (40) and a second end (42);
wherein said first auxiliary beam (30) is being fixed to said main beam (24) at said first end (26) thereof;
wherein said second auxiliary beam (38) is being fixed to said main beam (24) at said second end (28) thereof;
wherein said first grabbing mechanism (8) is being connected to said first auxiliary beam (30); and
wherein said second grabbing mechanism (10) is being connected to said second auxiliary beam (38).
Clause 10. A lifting yoke (200) according to clause 8 or 9, wherein said lifting yoke comprises a first beam actuator (36); wherein said first beam actuator (36) is being configured for adjusting the position of displacement, in said longitudinal direction (X), of said first grabbing mechanism (8), relative to said horizontally arranged beam (2); and/or
wherein said lifting yoke comprises a second beam actuator (44); wherein said second beam actuator is being configured for adjusting the position of displacement, in said longitudinal direction (X), of said second grabbing mechanism, relative to said horizontally arranged beam (2).
Clause 11. A lifting yoke (200) according to any of the preceding clauses, wherein said first beam actuator (36) and optionally also said second beam actuator (44) is/are being configured for remote controlling thereof.
Clause 12. A lifting yoke (200) according to any of the previous clauses, wherein said first grabbing mechanism (8) and said second grabbing mechanism (10) each comprises a fastening element (46), such as a throughgoing hole for fastening a shackle (48) or the like thereto.
Clause 13. A lifting yoke (200) according to clause 12 furthermore comprising a stress reducing chain/wire (50) having in each of its ends a shackle (48) or the like to be mounted to said fastening element (46) of said first grabbing mechanism (8) and to said second grabbing mechanism (10), respectively, wherein said stress reducing chain/wire (50) is being configured to be connected to the lifting chain/wire which, by means of a lifting boom of a crane, is configured for lifting said lifting yoke (200), thereby reducing the stress encountered by said first grabbing mechanism (8) and said second grabbing mechanism (10) due to the weight being lifted.
Clause 14. A lifting yoke (200) according to clause 13 furthermore comprising a “zero gravity” balancing device (52), such as a spring-loaded balancing device, having an upper attachment point (54) for an upper hoist and a lower attachment point (56) for a lower hoist, wherein said upper attachment point (54) is being configured to be connected to a lifting chain/wire for lifting by a lifting boom of a crane, and wherein said lower attachment point (56) is being configured for being attached to one or more attachment means (20) of said lifting yoke (200); and wherein said stress reducing chain/wire (50) is being connected to said lifting chain/wire to be lifted by a lifting boom of a crane.
Clause 15. A lifting yoke (200) according to any of the previous clauses, wherein the horizontal position of said first grabbing mechanism (8) essentially corresponds to said first extreme end (4) of said horizontally arranged beam (2); and wherein the horizontal position of said second grabbing mechanism (10) essentially corresponds to said second extreme end (6) of said horizontally arranged beam (2).
Clause 16. A lifting yoke (200) according to any of the previous clauses, wherein said horizontally arranged beam (2) comprises a number N of attachment means (20) for attachment, at different points, of a lifting chain/wire to be connected to a lifting boom of a crane, wherein said number N of attachment means (20) are being arranged along the longitudinal extension of said horizontally arranged beam (2), wherein N is an integer selected from the ranges of 2-55, such as 3-50, for example 4-45, such as 6-40, for example 10-35, e.g. 15-30, such as 20-25.
Clause 17. A lifting yoke (200) according to any of the previous clauses, wherein one or more of the attachment means (20) for attachment of a lifting chain/wire independently is being in the form of a threaded hole in said horizontally arranged beam (2) or eye bolts arranged at said horizontally arranged beam (2).
Clause 18. A lifting yoke (200) according to any of the previous clauses, wherein said mutual distance (D), in a horizontally direction (X), between said first clutch (12) and said second clutch (16) is being fixed at a distance, or is being configured to be variable at a distance; said distance falling within the ranges of 0.5 m-25 m, such as 1-24 m, for example 2-23 m, e.g. 3-22 m, such as 4-21 m, such as 5-20 m, for example 6-19 m, such as 7-18 m, for example 8-17 m, such as 9-16 m, e.g. 10-15 m, such as 11-14 m or 12-13 m.
Clause 19. A lifting yoke (200) according to any of the previous clauses, wherein said lifting yoke comprises a first distance element (58), wherein said first distance element is being connected to a first position at said horizontally arranged beam (2) in a downward pointing direction (Y); and wherein said first grabbing mechanism (8) is being connected to said first distance element (58) at a lower portion (60) thereof; and wherein said lifting yoke comprises a second distance element (62), wherein said second distance element is being connected to a second position at said horizontally arranged beam (2) in a downward pointing direction (Y); and wherein said second grabbing mechanism (10) is being connected to said second distance element (62) at a lower portion (64) thereof
Clause 20. A lifting yoke (200) according to any of the previous clauses, wherein said lifting yoke comprises a support arrangement (66) for aiding in aligning said lifting yoke (200), relative to a heavy element (300), prior to a lifting operation, wherein said support arrangement (66) comprises one or more support legs (68a,68b) each having a first end (70) and opposite second end (72), wherein in respect of one or more of said one or more support legs (68a,68b), said support leg at its first end (70) is/are being connected to said horizontally arranged beam (2) in such a way that said support leg (68a,68b) extends in a downward direction (Y); and wherein, in respect of one or more of said one or more support legs (68a,68b), said support leg at its second end (72) comprises a support element (74) comprising a support surface (76) for abutting a heavy element (300) prior to lifting thereof.
Clause 21. A lifting yoke (200) according to clause 20, wherein in respect of one or more of said one or more support legs (68a,68b), said support leg comprises an upper leg part (78) and a lower leg part (80); wherein said upper leg part (78) is being connected to said horizontally arranged beam (2) and wherein said lower leg part (80) is configured to be displaceable, in a longitudinal direction (Y) thereof, in relation to said upper leg part (78), between an upper extreme position and a lower extreme position; and wherein said lower leg part (80), at a lower portion thereof comprises said support element (74) comprising said support surface (76).
Clause 22. A lifting yoke (200) according to clause 21, wherein, in respect of one or more of said one or more support legs (68a,68b), said upper leg part (78) comprises hollow tube and wherein said lower leg part (80) is being loosely arranged in the interior of said hollow tube, thereby allowing said lower leg part (80) to be displaceable within the interior of said upper leg part (78); or wherein said lower leg part (80) comprises hollow tube and wherein said upper leg part (78) is being loosely arranged in the interior of said hollow tube, thereby allowing said lower leg part 80 to be displaceable outside said upper leg part (78).
Clause 23. A lifting yoke (200) according to any of the clauses 20-22, wherein, in respect of one or more of said one or more support legs (68a,68b), said support surface (76) comprises two mutually perpendicular partial surfaces (76a,76b) configured to abut an edge (304) of the heavy element (300) upon alignment of the lifting yoke (200) relative to said heavy element (300) and prior to lifting thereof.
Clause 24. A lifting yoke (200) according to any of the clauses 20-23, wherein in respect of one or more of said one or more support legs (68a,68b), said lifting yoke comprises a support leg suspension (82), wherein said support leg suspension comprises a support leg rail (84) having an extension in a direction (Z) which is essentially perpendicular to said horizontal direction (X) and to said vertical direction (Y), wherein said support leg rail (84) is being connected to said horizontally arranged beam (2); wherein said support leg suspension (82) comprises a displacement element (86) which is being coupled to said support leg rail (84), wherein said displacement element (86) is being configured to be able to be displaced along the extension of said support leg rail (84) and along the direction (Z) thereof, and wherein said support leg (68a,68b) is being connected to said displacement element (86).
Clause 25. A lifting yoke (200) according to clause 24, wherein in respect of one or more of said one or more support legs (68a,68b), said support leg suspension (82) comprises a support leg actuator (88); wherein said support leg actuator (88) is being configured for adjusting the position of said displacement element (86), relative to said support leg rail (84) and along said direction (Z).
Clause 26. A lifting yoke (200) according to clause 25, wherein in respect of one or more of said one or more support legs (68a,68b), said support leg actuator (88) is being configured to be remotely controlled.
Clause 27. A lifting yoke (200) according to any of the clauses 20-26, wherein the number of support legs (68a,68b) is two and wherein these two support legs (68a,68b) are being connected to said horizontally beam (2) at predetermined positions thereof.
Clause 28. A lifting yoke (200) according to any of the previous clauses, wherein in respect of said first grabbing mechanism (8) and said second grabbing mechanism (10), respectively, said clutch (12,16) comprises:
   a body (90), and
   a locking element (92);
wherein said body (90) comprises an oblong recess (94) defining an inner wall (96); and
wherein said body furthermore comprises a locking element channel (98) which extend from opposite sides (100a, 100b) of said inner wall (96) of said oblong recess (94) and into said body (90);
wherein said locking element (92) is being accommodated in said locking element channel (98);
wherein said locking element (92) is being configured, upon actuation thereof, to be slit in said locking element channel (98) between a retracted position and an expanded position, and vice versa;
wherein, when said locking element (92) is in its retracted position, access is provided from the outside into said oblong recess (94) of said body (90); and wherein, when said locking element is in its expanded position, access into said oblong recess (94) of said body (90) is being blocked by said locking element (92).
Clause 29. A lifting yoke (200) according to clause 28, wherein in respect of said first clutch (12) and/or said second clutch (16), said locking element channel (98) is having a circular extension, and wherein said locking element (92) is having a circular extension, thereby making said locking element (92) perform an essential rotational movement upon being slit in said locking element channel (98) between said retracted position and said expanded position, or vice versa.
Clause 30. A lifting yoke (200) according to clause 28, wherein in respect of said first clutch (12) and/or said second clutch (16), said locking element channel (98) is having a linear extension, and wherein said locking element (92) is having a linear extension, thereby making said locking element (92) perform an essential linear movement upon being slit in said locking element channel (98) between said retracted position and said expanded position, or vice versa.
Clause 31. A lifting yoke (200) according to any of the clauses 28-30, wherein in respect of said first clutch (12) and/or said second clutch (16), said clutch is being configured to engage and to disengage with a lifting anchor (302) of a heavy element 300, wherein said lifting anchor (302) is of the type comprising an exposed stem (306) having a throughgoing opening (308) in it.
Clause 32. A lifting yoke (200) according to any of the clauses 28-30, wherein in respect of said first clutch (12) and/or said second clutch (16), said locking element (92) comprises an elongate member (106) comprising in its one end a first prong (108a) and a second prong (108b) with an open space (109) therebetween, wherein said open space (109) is being configured for accommodating a stem (306) of a lifting anchor (302) of a heavy element to be lifted, wherein said lifting anchor (302) is of the type comprising said stem (306) with a head (310) in its one end, wherein said head (310) is having an extension in a direction perpendicular to a longitudinal extension of said stem (306), which is larger than the extension of said stem (306) in that direction.
Clause 33. A lifting yoke (200) according to clause 32, wherein said locking element channel (98) of said body (90) comprises a common cavity for accommodating both of the two prongs (108a,108b) of said locking element (92), or wherein said locking element channel (98) of said body (90) comprises two separate cavities, wherein each of these two cavities are configured for accommodating its own individual prong of the two prongs (108a,108b).
Clause 34. A lifting yoke (200) according to any of the clauses 1-27, wherein in respect of said first grabbing mechanism (8) and said second grabbing mechanism (10), respectively, said clutch (12,16) comprises:
   a body (90), and
   a locking element (92);
wherein said body comprises an electric motor (120) having an axle (110) and wherein said locking element (92) comprises a male thread (112) connected to said axle (110), whereby said electric motor (120) is being configured to rotate said axle (110) thereof in one or and in another rotational direction upon remote controlling thereof, thereby enabling engagement of said clutch (12,16) with a lifting anchor (302) of a heavy element, in a situation wherein said lifting anchor (302) comprises an exposed female thread (312).
Clause 35. A lifting yoke (200) according to clause 34, wherein said male thread (112) at its end comprises a tapered portion (114) for aiding in guiding said male thread (112) into a corresponding exposed female thread (312) of a lifting anchor (302) of a heavy element (300).
Clause 36. A lifting yoke (200) according to any of the clauses 1-27, wherein in respect of said first grabbing mechanism (8) and said second grabbing mechanism (10), respectively, said clutch (12,16) comprises:
   a body (90), and
   a locking element (92);
wherein said body comprises an electric motor (120) having an axle (110) and wherein said locking element (92) comprises a female thread (116) connected to said axle (110), whereby said electric motor (120) is being configured to rotate said axle (110) thereof in one or and in another rotational direction upon remote controlling thereof, thereby enabling engagement of said clutch (12,16) with a lifting anchor (302) of a heavy element, in a situation wherein said lifting anchor (302) comprises an exposed male thread (314).
Clause 37. A lifting yoke (200) according to clause 36, wherein said locking element at an end portion of said female thread (116) comprises a chute portion (118) for aiding in guiding said exposed male thread (314) of a lifting anchor (302) of a heavy element (300) into said female thread (116) of said clutch.
Clause 38. A lifting yoke (200) according to any of the clauses 1-27, wherein in respect of said first grabbing mechanism (8) and said second grabbing mechanism (10), respectively, said clutch (12,16) comprising a locking mechanism of the type used for lifting a standard freight container; thereby enabling engagement of said clutch (12,16) with a lifting anchor 302 of a heavy element (300), in a situation wherein said lifting anchor (302) comprises one or more locking holes of the type used in a standard freight container.
Clause 39. A lifting yoke (200) according to any of the previous clauses, wherein said lifting yoke comprises one or more, such as two image capturing devices (102a, 102b) for capturing images of an area in vicinity of the first grabbing mechanism (8) and the second grabbing mechanism (10), respectively.
Clause 40. A lifting yoke (200) according to any of the previous clauses, wherein said horizontally arranged beam (2) comprises a balancing ballast (104), such as a ballast made of concrete, for counteracting any tilting of the lifting yoke out of the (XY)-plane.
Clause 41. A lifting yoke (200) according to any of the preceding clauses, wherein said heavy element (300) is being a concrete element, such as a concrete wall element, or wherein said heavy element (300) is being an element for a wind turbine, such as a wind turbine blade or a tower section of a wind turbine, a silo or a section of a silo; or a freight container.
Clause 42. A lifting yoke (200) according to any of the preceding clauses, wherein said lifting yoke (200) comprises a battery (150) for providing power to one or more of said first clutch actuator (14,120); said second clutch actuator (18,120); said support leg actuator(s) (88); said first beam actuator (36); said second beam actuator (44).
Clause 43. A lifting yoke (200) according to any of the preceding clauses furthermore comprising a control system (400) for controlling the operation thereof, wherein said control system (400) comprising:
   a control panel (402) for enabling an operator to provide input instructions for controlling the operation of said lifting yoke; and
   a control interphase (404);
wherein said control panel (402) is being connected to said control interphase (404), thereby enabling conveying of operational instructions from said control panel (300) to said control interphase (404);
wherein said control interphase (404) is being coupled to one or more of the following elements of the lifting yoke (200): said first clutch actuator (14,120); said second clutch actuator (18,120); said support leg actuator(s) (88); said first beam actuator (36); said second beam actuator (44) for enabling remote controlling thereof.
Clause 44. A lifting yoke (200) according to clause 43, wherein said control panel (402) comprising input means (406), such as one or more knobs, joysticks, or the like for providing instructions by an operator.
Clause 45. A lifting yoke (200) according to clause 43 or 44, wherein said control panel (402) comprises a display (408) for displaying details relating to the operational status of said lifting yoke (200).
Clause 46. A lifting yoke (200) according to any of the clauses 43-45, wherein said control panel (402) comprises a monitor (410) for displaying images captured by said image capturing devices (102a,102b); wherein said control interphase (404) optionally comprising an image processing device (418) for processing images captured by said image capturing devices (102a,102b).
Clause 47. A lifting yoke (200) according to any of the clauses 43-46, wherein said control panel (402) and said control interphase (404) are being connected by a cable (416), thereby enabling wired controlling of said lifting yoke (200) from said control panel (402).
Clause 48. A lifting yoke (200) according to any of the clauses 43-47, wherein said control panel (402) comprises a first wireless communication unit (412) operating via electromagnetic radiation, and wherein said control interphase comprises a second wireless communication unit (414) operating via electromagnetic radiation; wherein said first wireless communication unit (412) and said second wireless communication unit (414) are configured to communicate with each other, thereby enabling wireless controlling said lifting yoke (200) from said control panel (402).
Clause 49. A lifting yoke (200) according to any of the clauses 43-48, wherein said control interphase (404) is being arranged at or near said horizontally arranged beam (2) of said lifting yoke (200).
Clause 50. A lifting yoke (200) according to any of the clauses 46-49, wherein said image processing device (416) of said control interphase (404) is being coupled to a central processing unit (CPU) (422) and a data storage (424), wherein said image processing device (418) is being configured, based on images received by said image capturing devices (102a, 102b), to analyze said images and to identify key features of the images received and relating to specific elements of the heavy element (300) to be lifted, and wherein said image processing device (418) is configured to determine, in respect of said first grabbing mechanism (8) and said second grabbing mechanism (10), whether or not said grabbing mechanism is located offset to a lifting anchor (302) of said heavy element (300), relative to said (X) direction and/or to said (Z) direction, and if so, wherein said control interphase (404) is configured to provide signals to one or more of: said first beam actuator (36); said second beam actuator (44) and said support leg actuator(s) (88) of said lifting yoke, in order to automatically make said first clutch (12) and/or said second clutch (16) approach the corresponding lifting anchor (302) of said heavy element (300).
Clause 51. A lifting yoke (200) according to clause 50, wherein said key features of the images received and identified by said image processing device (418) relate to one or more of the following features: said lifting anchor (302) of said heavy element (300); a rim of said heavy element (300), an edge of said heavy element (300), a surface of said heavy element (300).
Clause 52. A lifting yoke (200) according to clause 50 or 51, wherein the analysis being performed by said image processing device (418) is being based on patch features, such as colour distinction, edge detection, morphology, entropy of image patches making up such images.
Clause 53. A lifting yoke (200) according to any of the clauses 50-52, wherein said data storage (424) comprises a representation of learning images, and wherein said image processing device (418) is being configured to consult said representation of learning images, wherein one or more of said images of said representation of learning images comprises a real image or an artificially generated image, such as a computer generated image, of an upper part of a heavy element, and wherein in respect of wherein one or more of said images of said representation of learning images has been allocated with information correlating said image with information relating to the position at said upper part of a heavy element corresponding to said image.
Clause 54. A lifting yoke (200) according to any of the clauses 50-53, wherein said image processing device (418) is configured for employing deep learning algorithms and/or artificial intelligence and/or neural network in analyzing and in identifying said key features of the images received and relating to specific elements of the heavy element (300) to be lifted.
Clause 55. Use of a lifting yoke (200) according to any of the preceding clauses for lifting a heavy element.
Clause 56. Use according to clause 55, wherein said lifting element (300) is having a weight of 100 kg or more, such as 250 kg or more, for example 500 kg or more, such as 1,000 kg or more, e.g. 2,000 kg or more, or even 5,000 kg or more, or 10,000 kg or more.
Clause 57. Use according to clause 55 or 56, wherein said lifting element (300) is being a concrete element, such as a building element for a structure, such as a wall element; or an element for a wind turbine, such as a wind turbine blade or a tower section of a wind turbine, a silo or a section of a silo; or a freight container.
Clause 58. A method for lifting a heavy element (300) of the type having two or more lifting anchors (302) exposed at an edge (304) thereof; said method comprises the following step;
i) providing a lifting yoke (200) according to any to the clauses 1-54;
ii) providing said heavy element (300) to be lifted in an orientation in which said lifting anchors (302) are positioned at an upper edge (304) thereof;
iii) arranging said lifting yoke (200) above said heavy element (300) in an orientation essentially corresponding to a plane defined by said heavy element;
iv) approaching said lifting yoke (200) to said heavy element (300);
v) remotely enabling said first clutch (12) of said first grabbing mechanism (8) to engage with a first lifting anchor (302) of said heavy element (300), and remotely enabling said second clutch (16) of said second grabbing mechanism (10) to engage with a second lifting anchor (302) of said heavy element (300);
vi) lifting said lifting yoke (200), such as by a lifting boom of a crane, and thereby also lifting said heavy element (300).
Clause 59. A method according to clause 58, wherein said lifting yoke 200 is a lifting yoke according to any of the clauses 20-27, wherein step iv) comprises the following steps:
iva) approaching said lifting yoke (200) to said heavy element (300); and
ivb) aligning said lifting yoke (200) relative to the orientation of said heavy element (300) by making said support surface (76,76a,76b) of said support element (74) of said one or more support legs (68a,68b) abut an upper surface or edge (304) of said heavy element (300).
Clause 60. A method for moving a heavy element (300) of the type having two or more lifting anchors (302) exposed at an edge thereof from one location to another location, said method comprises the steps of:
a) performing steps i) to vi) of the method according to clause 58 or 59;
b) once lifted; moving the location of said heavy element (300), such as by moving the crane or the lifting boom thereof, to a new location;
c) lowering the lifting yoke (200), and thereby also lowering said heavy element (300), thereby making said heavy element (300) rest on a support at said new location;
d) remotely enabling said first clutch (12) of said first grabbing mechanism (8) to disengage with said first lifting anchor (302) of said heavy element (300), and remotely enabling said second clutch (16) of said second grabbing mechanism (10) to disengage with said second lifting anchor (302) of said heavy element (300);
e) moving said lifting yoke (200) from said new location.

### LIST OF REFERENCE NUMERALS

2 Horizontally arranged beam of lifting yoke
4 First extreme end of lift horizontally arranged beam of lifting yoke
6 Second extreme end of lift horizontally arranged beam of lifting yoke
8 First grabbing mechanism
10 Second grabbing mechanism
12 First clutch
14 First cutch actuator
15 Inner wire of clutch actuation cable
16 Second clutch
18 Second cutch actuator
19 Clutch actuation cable
20 Attachment means for attaching a lifting chain/wire to a lifting boom of a crane
22 Lifting chain/wire to be connected to a lifting boom of a crane
24 Main beam of horizontally arranged beam of lifting yoke
26 First end of main beam
28 Second end of main beam
30 First auxiliary beam of horizontally arranged beam of lifting yoke
32 First end of first auxiliary beam
34 Second end of first auxiliary beam
36 First beam actuator
38 Second auxiliary beam of horizontally arranged beam of lifting yoke
40 First end of second auxiliary beam
42 Second end of second auxiliary beam
44 Second beam actuator
46 Fastening element of first and second grabbing mechanism
48 Shackle
50 Stress reducing chain/wire
52 “Zero gravity” balancing device
54 Upper attachment point of balancing device
56 Lower attachment point of balancing device
58 First distance element associated with first grabbing mechanism
60 Lower portion of first distance element
62 Second distance element associated with second grabbing mechanism
64 Lower portion of second distance element
66 Support arrangement
68a,68b Support leg of support arrangement
70 First end of support leg
72 Second end of support leg
74 Support element of support leg
76 Support surface of support element
76a,76b Mutually perpendicular support surfaces
78 Upper leg part of support leg
80 Lower leg part of support leg
82 Support leg suspension
84 Support leg rail of support leg suspension
86 Displacement element of support leg suspension
88 Support leg actuator
90 Body of clutch
92 Locking element of clutch
94 Oblong recess in body of clutch
96 Inner wall of oblong recess
98 Locking element channel of body of clutch
100a, 100b Opposite sides of inner wall of oblong recess in body of clutch
102a, 102b Image capturing device
104 Balancing ballast of lifting yoke
106 Elongate member of locking element
108a, 108b First and second prongs of locking element
109 Open space between prongs
110 Axle
112 Male thread of locking element
114 Tapered portion of locking element
116 Female thread
118 Chute portion of female thread
120 Motor of clutch actuator
150 Battery
200 Lifting yoke
300 Heavy element, such as a concrete building element
302 Exposed lifting anchor of heavy element
304 Edge of heavy element
306 Stem of lifting anchor
308 Throughgoing opening of lifting anchor
310 Head of lifting anchor
312 Exposed female thread of lifting anchor
314 Exposed male thread of lifting anchor
400 Control system
402 Control panel of control system
404 Control interphase of control system
406 Input means of control panel
408 Display 408 of control panel
410 Monitor of control panel
412 First wireless communication unit
414 Second wireless communication unit
416 Cable
418 Image processing device
420 Encoded operational instructions
422 Central processing unit
424 Data storage

1. A lifting yoke (200) for lifting a heavy element (300); said heavy element being of the type comprising a body having two or more lifting anchors (302) exposed at an edge (304) thereof;
wherein said lifting yoke (200), in the orientation intended during lifting, comprises:
a horizontally arranged beam (2) having an extension in a longitudinal direction (X) between a first extreme end (4) and a second extreme end (6);
a first grabbing mechanism (8);
a second grabbing mechanism (10);
wherein said first grabbing mechanism (8) is being connected to said horizontally arranged beam (2) and is comprising a first clutch (12) which is being configured to be able to shift between an engaged configuration for engagement with a lifting anchor (302) of a heavy element (300), and a disengaged configuration for disengaging with said lifting anchor (302), and vice versa, wherein said first clutch (12) comprises a first clutch actuator (14), which is being configured for enabling remote controlling of the configuration of said first clutch (12);
wherein said second grabbing mechanism (10) is being connected to said horizontally arranged beam (2) and is comprising a second clutch (16) which is being configured to be able to shift between an engaged configuration for engagement with a lifting anchor (302) of a heavy element (300) and a disengaged configuration for disengaging with said lifting anchor (302), and vice versa, wherein said second clutch (16) comprises a second clutch actuator (18) which is being configured for enabling remote controlling of the configuration of said second clutch (16);
wherein said first clutch (12) and said second clutch (16) are being arranged at mutual distance (D);
wherein said lifting yoke (200) comprises one or more attachment means (20) for attachment of a lifting chain/wire (22) to be connected to a lifting boom of a crane;
wherein said first grabbing mechanism (8) and said second grabbing mechanism (10) each comprises a fastening element (46) for fastening a shackle (48) or the like thereto;
and wherein said lifting yoke (200) furthermore comprises a stress reducing chain/wire (50) having in each of its ends a shackle (48) or the like to be mounted to said fastening element (46) of said first grabbing mechanism (8) and to said second grabbing mechanism (10), respectively, wherein said stress reducing chain/wire (50) is being configured to be connected to the lifting chain/wire which, by means of a lifting boom of a crane, is configured for lifting said lifting yoke (200), thereby reducing the stress encountered by said first grabbing mechanism (8) and said second grabbing mechanism (10) due to the weight being lifted.

2. A lifting yoke (200) according to claim 1, wherein said horizontally arranged beam comprises:
a main beam (24) having a first end (26) and a second end (28); and
a first auxiliary beam (30) having a first end (32) and a second end (34);
wherein said first auxiliary beam (30) is being attached to said main beam (24) at said first end (26) thereof in such a way that said first auxiliary beam (30) is being displaceable, in said longitudinal direction (X), relative to said main beam (24);
wherein said first grabbing mechanism (8) is being connected to said main beam (24); and
wherein said second grabbing mechanism (10) is being connected to said first auxiliary beam (30).

3. A lifting yoke (200) according to claim 2, wherein said main beam (24), at least at a first end (26) thereof is being hollow, and wherein said first auxiliary beam (30) is being arranged in the interior of said hollow first end (26) of said main beam (24).

4. A lifting yoke (200) according to claim 2 wherein said lifting yoke comprises a first beam actuator (36); wherein said first beam actuator is being configured for adjusting the position of displacement, in said longitudinal direction (X), of said first auxiliary beam (30), relative to said main beam (24).

5. A lifting yoke 200 according to claim 1, wherein said horizontally arranged beam comprises:
a main beam (24) having a first end (26) and a second end (28); and
a first auxiliary beam (30) having a first end (32) and a second end (34);
a second auxiliary beam (38) having a first end (40) and a second end (42);
wherein said first auxiliary beam (30) is being attached to said main beam (24) at said first end (26) thereof in such a way that said first auxiliary beam (30) is being displaceable, in said longitudinal direction (X), relative to said main beam (24);
wherein said second auxiliary beam (38) is being attached to said main beam (24) at said second end (28) thereof in such a way that said second auxiliary beam (38) is being displaceable, in said longitudinal direction (X), relative to said main beam (24);
wherein said first grabbing mechanism (8) is being connected to said first auxiliary beam (30); and
wherein said second grabbing mechanism 10 is being connected to said second auxiliary beam (38).

6. (canceled)

7. A lifting yoke (200) according to claim 5, wherein said lifting yoke comprises a first beam actuator (36); wherein said first beam actuator (36) is being configured for adjusting the position of displacement, in said longitudinal direction (X), of said first auxiliary beam (30), relative to said main beam (24); and wherein said lifting yoke comprises a second beam actuator (44); wherein said second beam actuator is being configured for adjusting the position of displacement, in said longitudinal direction (X), of said second auxiliary beam (38), relative to said main beam (24).

8. A lifting yoke 200 according to claim 1, wherein said first grabbing mechanism (8) is being connected to said horizontally arranged beam (2) in such a way that said that said first grabbing mechanism (8) is being displaceable, in said longitudinal direction (X), relative to said horizontally arranged beam (2); and/or wherein said second grabbing mechanism (10) is being connected to said horizontally arranged beam (2) in such a way that said that said second grabbing mechanism (10) is being displaceable, in said longitudinal direction (X), relative to said horizontally arranged beam (2).

9. A lifting yoke 200 according to claim 8, wherein said horizontally arranged beam (2) comprises:
a main beam (24) having a first end (26) and a second end (28); and
a first auxiliary beam (30) having a first end (32) and a second end (34);
a second auxiliary beam (38) having a first end (40) and a second end (42);
wherein said first auxiliary beam (30) is being fixed to said main beam (24) at said first end (26) thereof;
wherein said second auxiliary beam (38) is being fixed to said main beam (24) at said second end (28) thereof;
wherein said first grabbing mechanism (8) is being connected to said first auxiliary beam (30); and
wherein said second grabbing mechanism (10) is being connected to said second auxiliary beam (38).

10. A lifting yoke (200) according to claim 8, wherein said lifting yoke comprises a first beam actuator (36); wherein said first beam actuator (36) is being configured for adjusting the position of displacement, in said longitudinal direction (X), of said first grabbing mechanism (8), relative to said horizontally arranged beam (2); and/or
wherein said lifting yoke comprises a second beam actuator (44); wherein said second beam actuator is being configured for adjusting the position of displacement, in said longitudinal direction (X), of said second grabbing mechanism, relative to said horizontally arranged beam (2).

11. A lifting yoke (200) according to claim 1, wherein said first beam actuator (36) and optionally also said second beam actuator (44) is/are being configured for remote controlling thereof.

12. (canceled)

13. (canceled)

14. (canceled)

15. (canceled)

16. (canceled)

17. A lifting yoke (200) according to claim 1, wherein said lifting yoke comprises a first distance element (58), wherein said first distance element is being connected to a first position at said horizontally arranged beam (2) in a downward pointing direction (Y); and wherein said first grabbing mechanism (8) is being connected to said first distance element (58) at a lower portion (60) thereof; and wherein said lifting yoke comprises a second distance element (62), wherein said second distance element is being connected to a second position at said horizontally arranged beam (2) in a downward pointing direction (Y); and wherein said second grabbing mechanism (10) is being connected to said second distance element (62) at a lower portion (64) thereof.

18. A lifting yoke (200) according to claim 1, wherein said lifting yoke comprises a support arrangement (66) for aiding in aligning said lifting yoke (200), relative to a heavy element (300), prior to a lifting operation, wherein said support arrangement (66) comprises one or more support legs (68a,68b) each having a first end (70) and opposite second end (72), wherein in respect of one or more of said one or more support legs (68a,68b), said support leg at its first end (70) is/are being connected to said horizontally arranged beam (2) in such a way that said support leg (68a,68b) extends in a downward direction (Y); and wherein, in respect of one or more of said one or more support legs (68a,68b), said support leg at its second end (72) comprises a support element (74) comprising a support surface (76) for abutting a heavy element (300) prior to lifting thereof.

19. (canceled)

20. (canceled)

21. (canceled)

22. A lifting yoke (200) according to claim 1, wherein in respect of one or more of said one or more support legs (68a,68b), said lifting yoke comprises a support leg suspension (82), wherein said support leg suspension comprises a support leg rail (84) having an extension in a direction (Z) which is essentially perpendicular to said horizontal direction (X) and to said vertical direction (Y), wherein said support leg rail (84) is being connected to said horizontally arranged beam (2); wherein said support leg suspension (82) comprises a displacement element (86) which is being coupled to said support leg rail (84), wherein said displacement element (86) is being configured to be able to be displaced along the extension of said support leg rail (84) and along the direction (Z) thereof, and wherein said support leg (68a,68b) is being connected to said displacement element (86); wherein in respect of one or more of said one or more support legs (68a,68b), said support leg suspension (82) comprises a support leg actuator (88); wherein said support leg actuator (88) is being configured for adjusting the position of said displacement element (86), relative to said support leg rail (84) and along said direction (Z).

23. (canceled)

24. A lifting yoke (200) according to claim 22, wherein in respect of one or more of said one or more support legs (68a,68b), said support leg actuator (88) is being configured to be remotely controlled.

25. (canceled)

26. A lifting yoke (200) according to claim 1, wherein in respect of said first grabbing mechanism (8) and said second grabbing mechanism (10), respectively, said clutch (12,16) comprises:
a body (90), and
a locking element (92);
wherein said body (90) comprises an oblong recess (94) defining an inner wall (96); and wherein said body furthermore comprises a locking element channel (98) which extend from opposite sides (100a,100b) of said inner wall (96) of said oblong recess (94) and into said body (90);
wherein said locking element (92) is being accommodated in said locking element channel (98);
wherein said locking element (92) is being configured, upon actuation thereof, to be slit in said locking element channel (98) between a retracted position and an expanded position, and vice versa;
wherein, when said locking element (92) is in its retracted position, access is provided from the outside into said oblong recess (94) of said body (90); and wherein, when said locking element is in its expanded position, access into said oblong recess (94) of said body (90) is being blocked by said locking element (92).

27. A lifting yoke (200) according to claim 26, wherein in respect of said first clutch (12) and/or said second clutch (16), said locking element channel (98) is having a circular extension, and wherein said locking element (92) is having a circular extension, thereby making said locking element (92) perform an essential rotational movement upon being slit in said locking element channel (98) between said retracted position and said expanded position, or vice versa.

28. A lifting yoke (200) according to claim 26, wherein in respect of said first clutch (12) and/or said second clutch (16), said locking element channel (98) is having a linear extension, and wherein said locking element (92) is having a linear extension, thereby making said locking element (92) perform an essential linear movement upon being slit in said locking element channel (98) between said retracted position and said expanded position, or vice versa.

29. (canceled)

30. (canceled)

31. (canceled)

32. (canceled)

33. (canceled)

34. (canceled)

35. (canceled)

36. (canceled)

37. A lifting yoke (200) according to claim 1, wherein said lifting yoke comprises one or more image capturing devices (102a,102b) for capturing images of an area in vicinity of the first grabbing mechanism (8) and the second grabbing mechanism (10), respectively.

38. (canceled)

39. (canceled)

40. (canceled)

41. A lifting yoke (200) according to claim 1 furthermore comprising a control system (400) for controlling the operation thereof, wherein said control system (400) comprising:
a control panel (402) for enabling an operator to provide input instructions for controlling the operation of said lifting yoke; and
a control interphase (404);
wherein said control panel (402) is being connected to said control interphase (404), thereby enabling conveying of operational instructions from said control panel (300) to said control interphase (404);
wherein said control interphase (404) is being coupled to one or more of the following elements of the lifting yoke (200): said first clutch actuator (14,120); said second clutch actuator (18,120); said support leg actuator(s) (88); said first beam actuator (36); said second beam actuator (44) for enabling remote controlling thereof.

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. A method of u sing of a lifting yoke (200) according to claim 1, for lifting a heavy element.

54. (canceled)

55. (canceled)

56. A method for lifting a heavy element (300) of the type having two or more lifting anchors (302) exposed at an edge (304) thereof; said method comprising the following steps;
i) providing a lifting yoke (200) according to claim 1;
ii) providing said heavy element (300) to be lifted in an orientation in which said lifting anchors (302) are positioned at an upper edge (304) thereof;
iii) arranging said lifting yoke (200) above said heavy element (300) in an orientation essentially corresponding to a plane defined by said heavy element;
iv) approaching said lifting yoke (200) to said heavy element (300);
v) remotely enabling said first clutch (12) of said first grabbing mechanism (8) to engage with a first lifting anchor (302) of said heavy element (300), and remotely enabling said second clutch (16) of said second grabbing mechanism (10) to engage with a second lifting anchor (302) of said heavy element (300);
vi) lifting said lifting yoke (200), and thereby also lifting said heavy element (300).

57. (canceled)

58. (canceled)
